(19) United States
(12) Patent Application Publication
(10) Pub. No.: US 2009/0086868 A1
(43) Pub. Date: Apr. 2, 2009

(54) CLOCK DATA RECOVERY CIRCUIT

(75) Inventors: Mikio Shiraishi, Yokohama-shi (JP); Takuma Aoyama, Fujisawa-shi (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/211,844

(22) Filed: Sep. 17, 2008

(30) Foreign Application Priority Data
Sep. 28, 2007 (JP) 2007-255451

(51) Int. Cl. H04L 7/02

(52) U.S. Cl. 375/359

(57) ABSTRACT

A clock data recovery circuit which reproduces clock contained in data sequence from data sequence which is serially input includes a digital control oscillator outputting reproduced clock whose frequency is controlled according to a control signal. A phase comparator compares a phase of the data sequence and a phase of the reproduced clock. A digital control circuit produces the control signal in accordance with an output of the phase comparator, first control information indicating a first period for which the frequency of the reproduced clock is changed, and a second control information indicating a number of steps by which the frequency of the reproduced clock is changed.

### CROSS-REFERENCE TO RELATED APPLICATIONS

This application is based upon and claims the benefit of priority from prior Japanese Patent Application No. 2007-255451, filed Sep. 28, 2007, the entire contents of which are incorporated herein by reference.

### BACKGROUND OF THE INVENTION

1. Field of the Invention

The present invention relates to clock data recovery circuits which reproduce a clock for reading data from an input a data sequence, and in particular it is used for a receiving section of a serial-data transmission circuit.

2. Description of the Related Art

For the purpose of high-speed serial transmission of the digital data, only data is generally sent without sending a clock and a receiver reproduces a clock from a data sequence. The circuit which reproduces the clock for reading data from the received data sequence is called a clock data recovery circuit (CDR). The method of generating a reproduced clock in CDR includes the PLL type which controls a frequency of a built-in oscillator, and the DLL type which uses a variable delay circuit or a phase-shift circuit to shift a phase of the standard clock supplied from outside. Moreover, method of controlling them roughly includes analog types and digital types. The PLL type is suited for a control by the analog type, and the DLL type is suited for digital systems.

Control by the digital type can decrease influence affected by a change in environment of devices or variations in components introduced in a semiconductor manufacturing process. Therefore, it is used in various fields. CDR is not an exception, either. However, since the conventional digital control type CDR uses a DLL to shift a phase of a standard clock for control, the frequency offset and the spread spectrum clocking (SSC) reduce the jitter tolerance. The frequency offset refers to a deviation of the clock frequency contained in received data from a specific communication rate (bit rate). The jitter tolerance refers to the maximum sine wave jitter amplitude which can transmit and receive data with a bit error rate below a specific one.

Jpn. Pat. Appln. KOKAI Publication No. 2005-64739 discloses an example of DLL type CDR. The DLL type CDR comprises a pulse insertion circuit which inserts a pulse into a first phase advance signal or a first phase delay signal to produce a second phase advance signal or a second phase delay signal, a frequency difference generator which generates frequency difference information containing data corresponding to a frequency difference between a reproduced clock and a standard clock and a polar data which indicates whether the frequency of the reproduced clock is higher or lower than the frequency of the standard clock based on the second phase advance signal and the second phase delay signal. The pulse insertion circuit calculates a cycle for which the frequency difference is corrected based on the frequency difference information, so that when the first phase advance or delay signal is not input in the cycle, it inserts a pulse according to the polar data.

### BRIEF SUMMARY OF THE INVENTION

According to an aspect of the present invention, there is provided a clock data recovery circuit which reproduces clock contained in data sequence from data sequence which is serially input comprising: a digital control oscillator outputting reproduced clock whose frequency is controlled according to a control signal; a phase comparator comparing a phase of the data sequence and a phase of the reproduced clock; a digital control circuit producing the control signal in accordance with an output of the phase comparator, first control information indicating a first period for which the frequency of the reproduced clock is changed, and a second control information indicating a number of steps by which the frequency of the reproduced clock is changed.

### BRIEF DESCRIPTION OF THE SEVERAL VIEWS OF THE DRAWING

FIG. 1 is a block circuit diagram showing a configuration of a clock data recovery circuit according to a first embodiment of the present invention.

FIG. 2 is a timing chart showing an example of operation of CDR of the first embodiment.

FIG. 3 is a specific circuit configuration diagram of a phase comparator in CDR of the first embodiment.

FIGS. 4A and 4B are specific circuit configuration diagrams of a serial-parallel converter in CDR of the first embodiment.

FIG. 5 is a specific circuit configuration diagram of a jitter removal filter in CDR of the first embodiment.

FIG. 6 is a specific circuit configuration diagram of a phase adjustment pulse generator in CDR of the first embodiment.

FIG. 7 is a specific circuit configuration diagram of a frequency difference detection filter in CDR of the first embodiment.

FIG. 8 is a specific circuit configuration diagram of a control signal generator in CDR of the first embodiment.

FIG. 9 is a specific circuit configuration diagram of a digital control oscillator in CDR of the first embodiment.

FIG. 10 is a specific circuit configuration diagram of a frequency divider in CDR of the first embodiment.

FIG. 11 is a block circuit diagram showing a configuration of CDR according to a second embodiment of the present invention.

FIG. 12 is a timing chart showing an example of operation of CDR of the second embodiment.

FIG. 13 is a specific circuit configuration diagram of a frequency difference detection filter in CDR of the second embodiment.

FIG. 14 is a specific circuit configuration diagram of a control signal generator in CDR of the second embodiment.

FIG. 15 is a block circuit diagram showing a configuration of CDR according to the third embodiment of the present invention.

FIG. 16 is a timing chart which shows an example of operation of CDR of the third embodiment.

FIGS. 17A and 17B are timing charts which show a difference in operation of CDR between the second embodiment shown in FIG. 11 and the third embodiment shown in FIG. 15.

FIG. 18 is a specific circuit configuration diagram of a phase adjustment pulse generator in CDR of the third embodiment.

FIG. 19 is a specific circuit configuration diagram of a frequency difference detection filter in CDR of the third embodiment.

FIG. 20 is a specific circuit configuration diagram of a control signal generator in CDR of the third embodiment.

FIG. 21 is a specific circuit configuration diagram of a frequency interpolation circuit in CDR of the third embodiment.

FIG. 22 is a specific circuit configuration diagram of a timer in the frequency interpolation circuit shown in FIG. 21.

FIG. 23 is a state transition diagram of the control circuit used in the frequency interpolation circuit shown in FIG. 21.

FIG. 24 is a characteristic figure for explaining effects of CDR of the third embodiment.

### DETAILED DESCRIPTION OF THE INVENTION

Now, the present invention is explained through embodiments with reference to drawings. In the explanation, the same reference numerals are given to identical components across drawings, and the overlapping explanation is omitted.

### First Embodiment

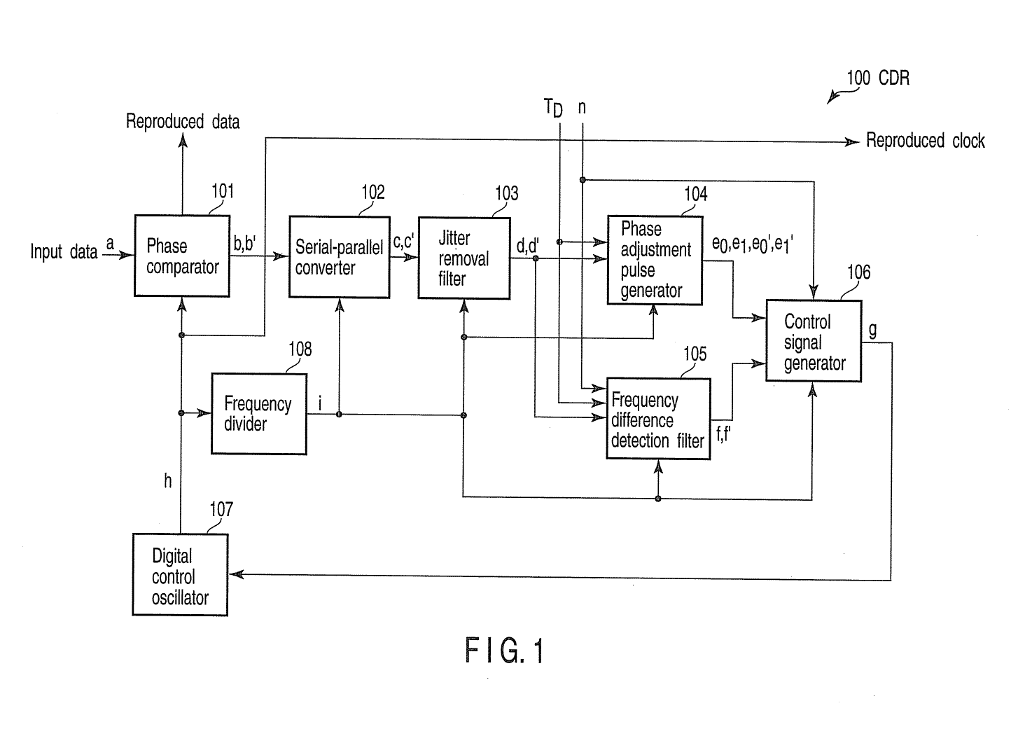

FIG. 1 is a block circuit diagram showing a configuration of clock data recovery circuit (called CDR, hereinafter) 100 according to the first embodiment of the present invention. In FIG. 1, 101 is a phase comparator, 102 a serial-parallel converter, 103 an irregular jitter (RJ) removal filter, 104 a phase adjustment pulse generator, 105 a frequency difference detection filter, 106 a control signal generator, 107 a digital control oscillator (DCO), and 108 frequency divider.

Phase comparator 101 compares bit serial input data a with a phase of clock (reproduced clock) h which is generated by digital control oscillator 107. That is, phase comparator 101 provides the serial-parallel converter 102 with serial output signals b and b′ which are in synchronization with clock h and show that the phase of an edge of clock is advanced or delayed to the center of one bit period in data.

Serial-parallel converter 102 converts bit serial signals b and b′ into bit parallel signals c and c′, and outputs them in synchronization with rising edges of divided clock i obtained through division of reproduced clock h by frequency divider 108. Bit parallel signals c and c′ are input to jitter removal filter 103.

Jitter removal filter 103 accumulates the difference acquired by subtracting the number of bit “1” contained in one word of bit parallel signal c′ from that of bit 1 contained in one word of bit parallel signal c. When the accumulated value exceeds the positive or negative predetermined threshold, jitter removal filter 103 asserts phase up-and-down signals d and d′ and sets the accumulated value to zero. Outputs d and d′ of jitter removal filter 103 are input to phase adjustment pulse generator 104 and frequency difference detection filter 105.

Frequency increase-or-decrease time width T_{D} (first control information) is input to phase adjustment pulse generator 104 as a control parameter. Phase adjustment pulse generator 104 outputs frequency increase-or-decrease pulses e₀, e₁, e₀′, and e₁′. Among these pulses, pulses e₀ and e₁ (frequency increase pulse) increase the frequency of the oscillation in digital control oscillator 107, while pulse e₀′ and e₁′ (frequency decrease pulse) decrease it. The frequency increase-or-decrease pulses e₀, e₁, e₀′, and e₁′ are used for increasing or decreasing the phase of reproduced clock h.

When output d of jitter removal filter 103 rises, phase adjustment pulse generator 104 sets pulse e₀ to 1 for one cycle of divided clock i. Then, phase adjustment pulse generator 104 sets pulse e₁′ to 1 for one cycle of divided clock i after elapse of period T_{D} from the rise of output d. When output d rises again during period T_{D}, period T_{D} starts from the last rising edge of output d. In the meantime, neither pulse e₀ nor e₁′ rises. Thus, since the oscillation frequency is increased by the pulse e₀, and then, returned to the original value by the pulse e₁′, the phase of the reproduced clock h advances in proportion to the interval between rising edges of pulses e₀, and e₁′.

On the other hand, when the other output d′ of jitter removal filter 103 rises, phase adjustment pulse generator 104 sets e₀′ to 1 for one cycle of divided clock i. Phase adjustment pulse generator 104 sets pulse e₁ to 1 for one cycle of divided clock i after elapse of period T_{D} from the rise of output d′. When output d′ rises again during period T_{D}, period T_{D} starts from the last rising edge of output d′. In the meantime, neither pulse e₀′ nor e₁ rises. Thus, since the oscillation frequency is decreased by the pulse e₀′, and then, returned to the original value by the pulse e₁, the phase of the reproduced clock h delays in proportion to the interval between rising edges of pulses e₀′, and e₁. Frequency increase-or-decrease pulses e₀, e₁, e₀′, and e₁′ are input to control signal generator 106.

Frequency increase-or-decrease step number n (second control information) is input to control signal generator 106 as a control parameter. Control signal generator 106 multiplies frequency increase-or-decrease pulses e₀, e₁, e₀′, and e₁′ by frequency increase-or-decrease step number n, uses outputs f and f′ to perform an operation of n×(e₀+e₁−e₀′−e₁′)+f−f′, adds the operation result to output g which appeared one cycle before in divided clock i and is stored inside control signal generator 106, and stores the addition result as new signal g.

Frequency increase-or-decrease time width T_{D} and frequency increase-or-decrease step number n are input to frequency difference detection filter 105 control parameters. Frequency difference detection filter 105 elongates outputs d and d′ of jitter removal filter 103 to the same period as T_{D}, multiplies elongated d and d′ by n, and determines the difference between the multiplication results, thereby reproduces the processing performed to pulses e₀, e₁, e₀′, and e₁′ inside control signal generator 106. Moreover, frequency difference detection filter 105 accumulates the difference for a predetermined period and compares the accumulation result with a positive and negative thresholds, thereby determines whether the increment of the average frequency of input data is equal to or more than half the minimum change width F_{S} of the oscillation frequency of digital control oscillator 107. Frequency difference detection filter 105 sets output f to 1 for one period of divided clock i when the sign of the increment is positive, or sets output f′ to 1 for one period of divided clock i when the sign of the increment is negative, thereby increases or decreases the oscillation frequency of digital control oscillator 107 by F_{S}. Output g of control signal generator 106 is input to digital control oscillator 107, and controls the frequency of output h of digital control oscillator 107.

CDR of FIG. 1 is reset by a reset circuit (not shown) so that the oscillation frequency of digital control oscillator 107 has a frequency f₀ 0sufficiently near the bit rate.

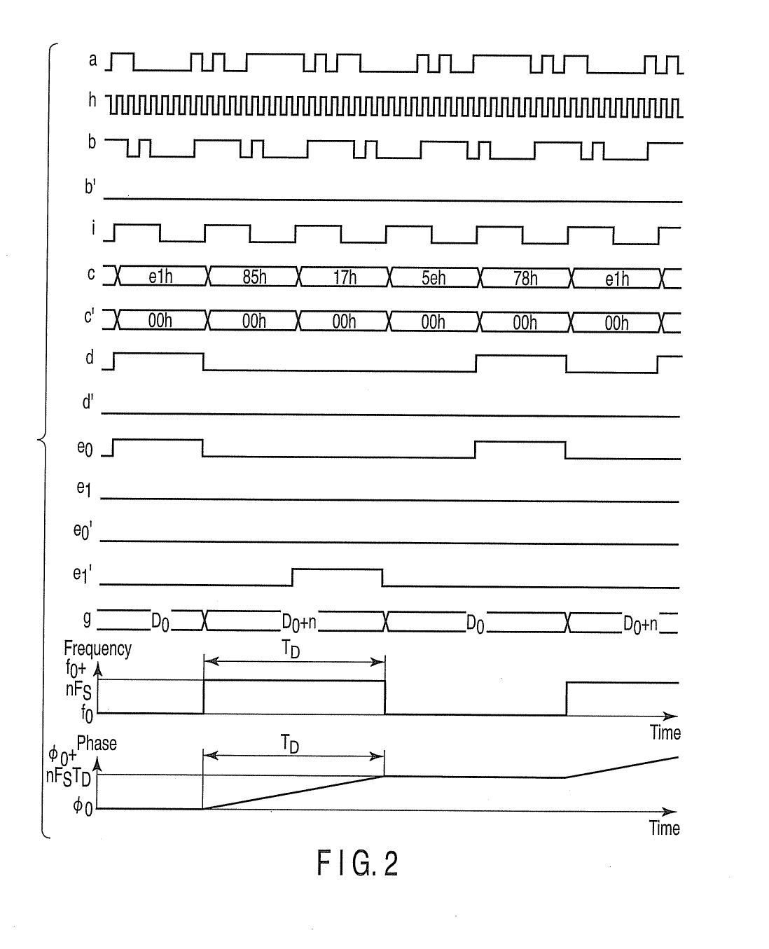

FIG. 2 is a timing chart which shows an example of operation of CDR shown in FIG. 1. FIG. 2 shows the case where the phase of reproduced clock h delays to the transmission clock (more specifically, the center of each bit section of data) contained in the data of input data a. As shown in FIG. 2, the oscillation frequency of digital control oscillator 107 changes like a pulse nF_{S} times in the period T_{D}, and the phase of reproduced clock h changes by a fixed inclination in a ramp manner in this frequency pulse period. The amount of change of the phase is expressed with nF_{S}×T_{D}. The phase of reproduced clock h keeps changing with the frequency f₀ of digital control oscillator 107 after reset release. The phase which changes with f₀ is assumed to be φ₀, and the deviation from this standard phase is shown as the phase of reproduced clock h.

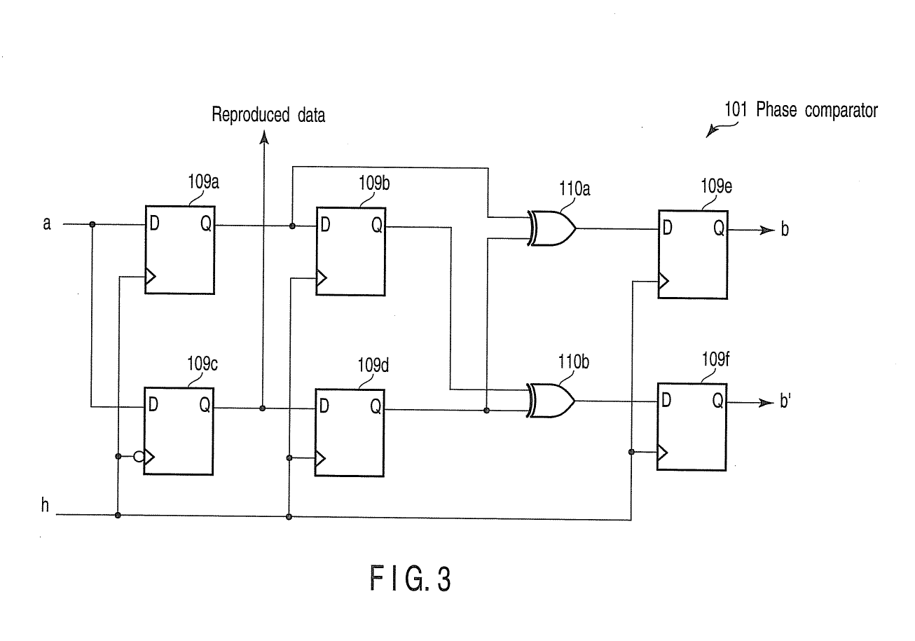

FIG. 3 shows an example of a specific circuit configuration of the phase comparator 101 in CDR of FIG. 1. In FIG. 3, 109a-109f are D-type flip-flops, and 110a and 110b exclusive OR gates. In FIG. 3, bit serial input data a is input to D-type flip-flops 109a and 109c. Reproduced clock h is input to D-type flip-flop 109a as a synchronization signal, and the inverted reproduced clock h is input to D-type flip-flop 109c as a synchronization signal. And each output of flip-flops 109a and 109c is input to D-type flip-flops 109b and 109d, respectively. The output of D-type flip-flop 109c is also supplied to other circuits (not shown) as reproduced data. Reproduced clock h is input to both flip-flops 109b and 109d as a synchronization signal. An output of flip-flop 109d is input to exclusive OR gate 110a with an output of flip-flop 109a, and an output of a flip-flop 109d is input to exclusive OR gate 110b with an output of flip-flop 109b. Each output of exclusive OR gates 110a and 110b is input to D-type flip-flops 109e and 109f, respectively. Reproduced clock h is input to flip-flops 109e and 109f as a synchronization signal. Bit serial output signals b and b′ are output from flip-flops 109e and 109f, respectively.

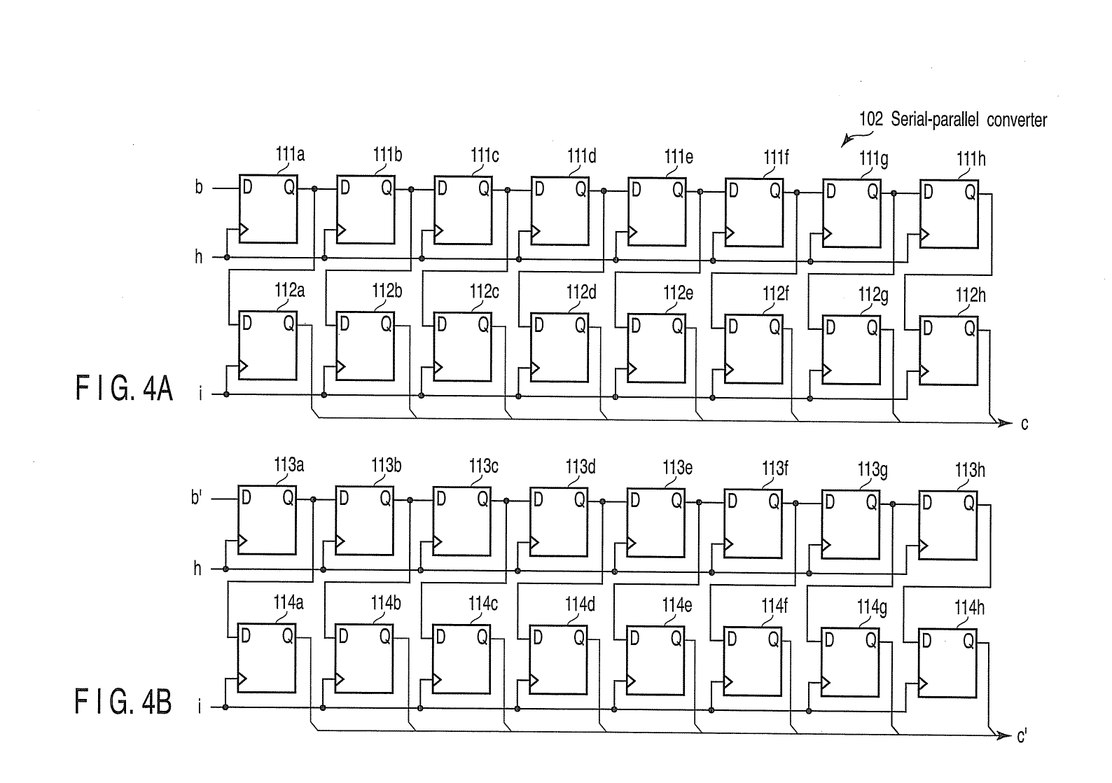

FIGS. 4A and 4B show an example of a specific circuit configuration of serial-parallel converter 102 in CDR of FIG. 1. Serial-parallel converter 102 has a circuit shown in FIG. 4A, and a circuit shown in FIG. 4B. The circuit shown in FIG. 4A outputs signal c from bit serial signal b. The circuit shown in FIG. 4B outputs signal c′ from bit serial signal b′. The circuit shown in FIG. 4A consists of eight D-type flip-flops 111a-111h and eight D-type flip-flops 112a-112h. The circuit shown in FIG. 4B consists of eight D-type flip-flops 113a-113h and eight D-type flip-flops 114a-114h.

D-type flip-flops 111a-111h and 113a-113h use reproduced clock h as a synchronization signal. D-type flip-flops 112a-112h and 114a-114h use divided clock i as a synchronization signal.

In the circuit shown in FIG. 4A, eight D-type flip-flops 111a-111h shift serial signal b one after another, and store it, and eight D-type flip-flops 112a-112h output 8-bit parallel signal c. Similarly, in the circuit shown in FIG. 4B, eight D-type flip-flops 113a-113h shift bit serial signal b′ one after another, and store it, and eight D-type flip-flops 114a-114h output 8-bit parallel signal c′.

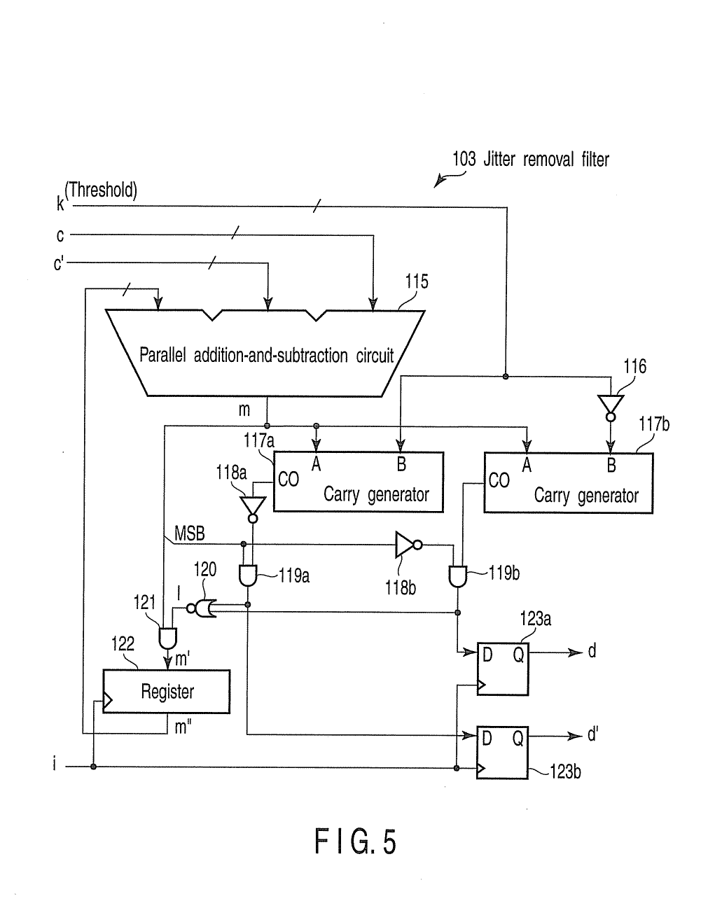

FIG. 5 shows an example of a specific circuit configuration of jitter removal filter 103 in CDR of FIG. 1. In FIG. 5, 115 is a parallel addition-and-subtraction circuit, 116 an inverter (multiple bits), 117a and 117b carry generators, 118a and 118b inverters, 119a and 119b logical product (AND) gates, 120 a NOR gate, 121 a logical product (AND) gate (multiple bits), 122 a register, and 123a and 123b D-type flip-flops.

Parallel addition-and-subtraction circuit uses accumulation result m″ (described later) and outputs c and c′ of serial-parallel converter 102 to calculate m=m″+[the number of 1 contained in c]−[the number of 1 contained c′] in two's complement representation. For parallel addition-and-subtraction circuit, a parallel addition circuit is disclosed in U.S. Pat. No. 4,879,677, for example. Subtraction can also be performed by addition of complements. Addition-and-subtraction result m and threshold k are input to carry generators 117a and 117b.

The carry generators 117a and 117b perform the carry from the most significant bit which results in addition of the inputs indicated by references A and B in FIG. 5. It is well known that it is not necessary to calculate the sum of A+B for this operation, and that operation is applied to carry look-ahead circuits etc. For addition of a negative binary number, 1 is put in front of the most significant bit of negative numbers to be added so that they have the same number of bits. Any number of 1 can be put as long as negative numbers to de added have the same number of bits.

Aforementioned output m and threshold k(>0) are input to two inputs A and B of carry generator 117a, respectively. When output m is negative and m≧−k, which results in m+k≧0, then carry output signal CO is 1 in order to convert all invisible 1 which infinitely-repeatedly exist in higher bits than the most significant bit (MSB) into 0. On the other hand, when m<−k, which results in m+k<0, then CO is 0. That MSB of output m is 1 shows that output m is negative. Therefore, detecting that MSB of output m is 1 and output CO of carry generator 117a is 0 through inverter 118a and the logical product gate 119a can determine that m<−k.

On the other hand, output m and inverted signal of k (the complement of 1, i.e., −k−1) are input to two inputs A and B of carry generator 117b, respectively. When output m is positive and m≦k, which results in m+(−k−1)<0, then all invisible 1 which infinitely-repeatedly exist in higher bits than MSB of output m+(−k−1) can remain as they are, and carry output signal CO is 0. On the other hand, when m>k, which results in m+(−k−1)≧0, then carry output signal CO is 1 in order to convert all the invisible 1 into 0. That the MSB of output m is 0 shows that output m is positive. Therefore, detecting that MSB of output m is 0 and output CO of carry generator 117b is 1 through inverter 118b and the logical product gate 119b can determine that m>k.

Thus determined result is stored in D-type flip-flop 123a (when m>k) or D-type flip-flop 123b (when m<−k) and is supplied to the logical product gate (multiple bits) 121 through NOR gate 120. The output of NOR gate 120 is 0 when m>k or m<−k, output m′ of the logical product gate 121 is 0, and the stored content of register 122 is cleared at the time of next rise in reproduced clock i. On the other hand, when −k≦m≦k, then m′=m and the output m of parallel addition-and-subtraction circuit 115 is stored by register 122. Output m″ of register 122 is again returned to parallel addition-and-subtraction circuit 115, and accumulation is performed whenever reproduced clock i rises.

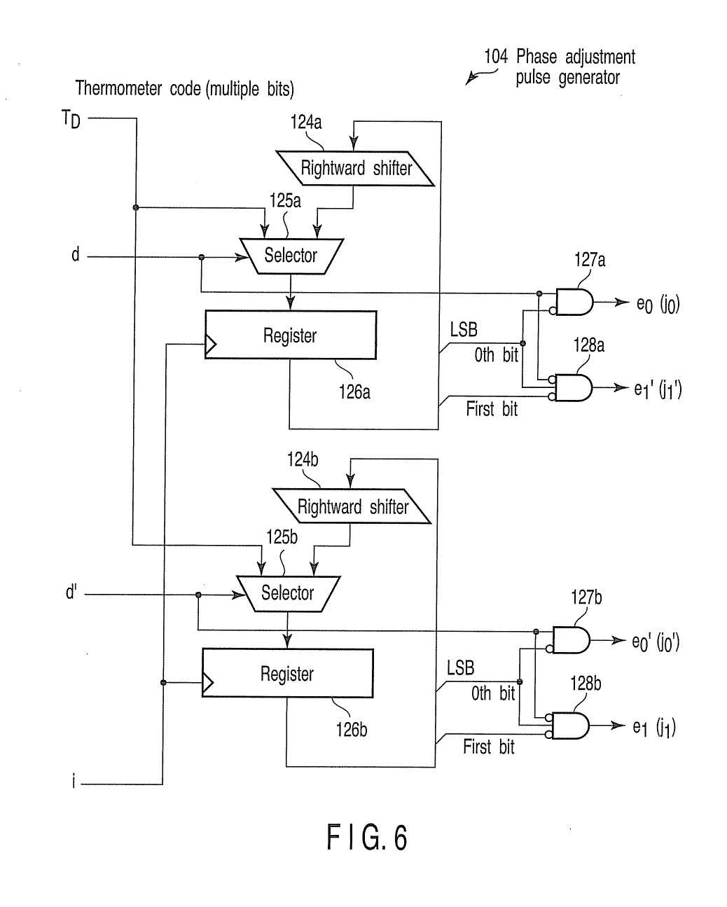

FIG. 6 shows an example of a specific circuit configuration of phase adjustment pulse generator 104 in CDR of FIG. 1. In FIG. 6, 124a and 124b are rightward shifters, 125a and 125b are selectors, 126a and 126b are registers, 127a, 127b, 128a, and 128b logical product gates with a inverted input (small round mark in the figure). Hereinafter, the small round mark in figures indicates whether a logical product gate has an inverted input or not, and explanation on it is omitted.

Phase adjustment pulse generator 104 shown in FIG. 6 is for realizing control by frequency increase-or-decrease time width T_{D} shown in FIG. 2. Since all outputs of phase adjustment pulse generator 104 are accumulated in the end, phase adjustment pulse generator 104 must output frequency reduction pulse e₁′ after elapse of time T_{D} from outputting of frequency increase pulse e₀. This operation is realized by representing T_{D} by a thermometer code, which represents a value by the number of consecutive bit “1” from the least significant bit (LSB). When signal d is 1, selector 125a selects the left-hand input, and, therefore, value T_{D} is loaded to register 126a. This value is shifted rightward by one bit by rightward shifter 124a, and is returned to the right-hand input of selector 125a. For this reason, when d=0, the data in register 126a is shifted rightward in synchronization with the rise of divided clock i.

The logical product gate 127a sets frequency increase pulse e₀ to 1, when it detects that d=1 and LSB of register 126a is 0. Since LSB=1 due to loading of T_{D}, the period for which e₀=1 is only one cycle of the clock. Then, a shifting starts when d=0. And when logical product gate 128a detects that register 126a is in a state just before all its bits are 0, i.e., that its lowest two bits are 01, frequency decrease pulse e₁′ is set to 1. Since all the bits of register 126a are set to 0 in the following clock cycle, the period for which e₁′=1 is also only one cycle. Then, phase adjustment pulse generator 104 returns to an initial state, and when d=1 again, the above-mentioned operation is repeated. When d=1 in the state while the bit of 1 remains in register 126a, neither pulse e₀ nor e₁′ rises, the shifting starts and period T_{D} starts after d=0.

Since the operation is also the same about a circuit which produces pulses e₀′ and e₁ and consists of rightward shifter 124b, selector 125b, register 126b, and logical product gates 127b and 128b, explanation on it is omitted.

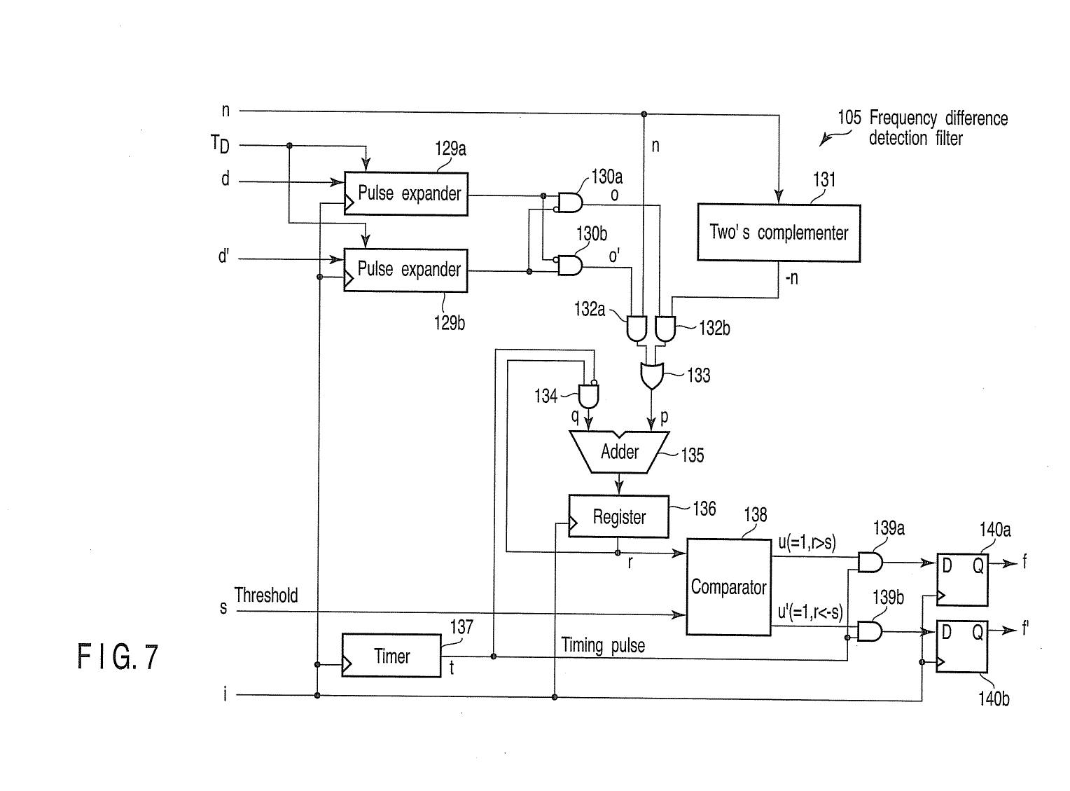

FIG. 7 shows an example of a specific circuit configuration of frequency difference detection filter 105 in CDR of FIG. 1. In FIG. 7, 129a and 129b are pulse expanders, 130a, 130b, 139a, and 139b logical product gates, 131 a two's complementer, 132a, 132b, and 134 logical product gates (multiple bits), 133 a logical sum gate (multiple bits), 135 an adder, 136 a register, 137 a timer, 138 a comparator, and 140a and 140b D-type flip-flops.

Frequency difference detection filter 105 shown in FIG. 7 uses signals d and d′ to calculate a change in the frequency of input data, uses its average to determine whether the frequency of reproduced clock h should be changed, and generates signals f and f′ for increasing or decreasing the frequency of reproduced clock h by ±one step, i.e., by ±Fs. In phase adjustment pulse generator 104, since signals d and d′ receive the above-mentioned processing, simply accumulating these cannot determine the exact frequency change. Therefore, signals d and d′ are elongated to T_{D} using the pulse expanders 129a and 129b, and where these expanded results are identical is removed by logical product gates 130a and 130b. Outputs o and o′ of logical product gates 130a and 130b are expanded by the number of bits and input to one input terminal of each of logical product gates 132a and 132b which process multiple bits. Multiple-bit logical sum gate 133 generates the logical sum of outputs of logical product gates 132a and 132b. Since frequency increase-or-decrease step number n, which controls the number of steps, and its sign-inverted form (−n) which is produced by the two's complementer 131 are input to the other input of each of the logical product gates 132a and 132b, output p of logical sum gate 133 takes −n, 0, or n. Therefore, the time width of the output of logical sum gate 133 is defined by signal o and o′, and is controlled to take the same change as the change in frequency.

Output p of the logical sum gate 133 is accumulated by an accumulator which consists of adder 135, register 136, and logical product gate 134, and accumulation result r is input to comparator 138. Comparator 138 compares accumulation result r with threshold s and its sign-inverted form −s, and changes judgment signal u and u′ according to the comparison result. When r>s, u=1, otherwise u=0. When r<−s, u′=1, otherwise u′=0. Threshold s is set as approximately half the number of the cycle of operation clock i which constitutes the interval of timing pulse t output from timer 137. Timer 137 counts the rise of divided clock i for a predetermined number of times, and generates timing pulse t which has the same width as one cycle of divided clock i and a fixed interval. Timing pulse t is supplied to the inverted input of logical product gate 134 and one input terminal of each logical product gates 139a and 139b. Therefore, the contents of the register 136 are cleared whenever t=1, and values of judgment signals u and u′ just before the clearance are stored in D-type flip-flops 140a and 140b and output as frequency increase-or-decrease pulses f and f′, respectively.

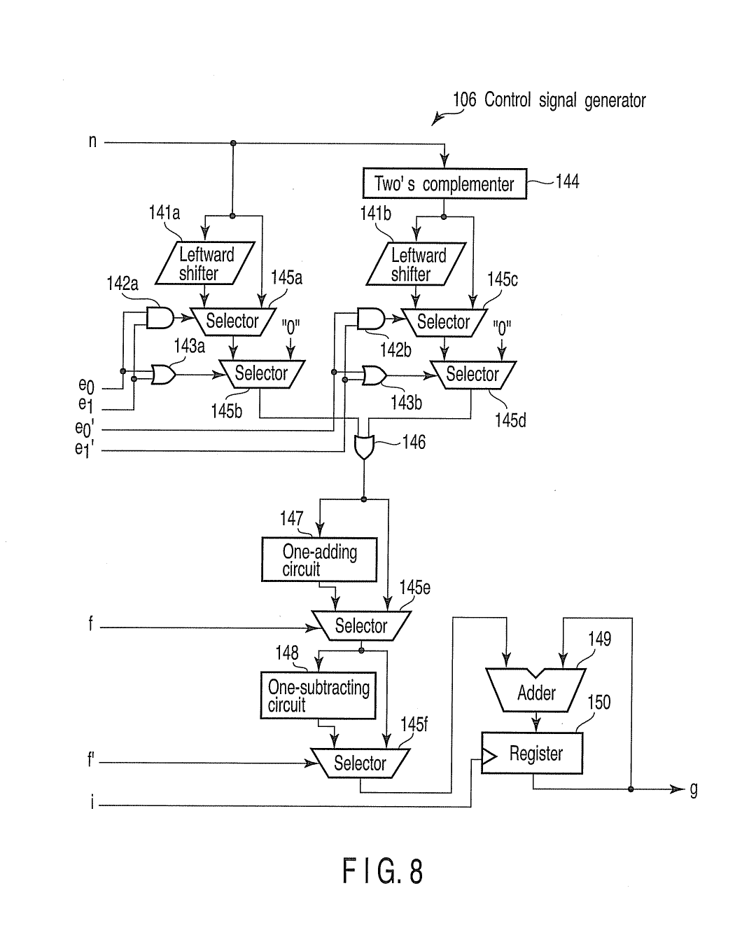

FIG. 8 shows an example of a specific circuit configuration of control signal generator 106 in CDR of FIG. 1. In FIG. 8, 141a and 141b are leftward shifters, 142a and 142b logical product gates, 143a and 143b logical sum gates, 144 a two's complementer, 145a-145f selectors, 146 a logical sum gate (multiple bits), 147 one-adding circuit (incrementer), 148 one-subtracting circuit (decrementer), 149 an adder, and 150 a register.

The circuit shown in FIG. 8 processes frequency increase-or-decrease pulses e₀, e₁, e₀′ and e₁′ and frequency increase-or-decrease pulses f and f′ to produce control signal g. Control signal g is supplied to digital control oscillator 107.

Here, frequency increase-or-decrease pulses e₀ and e₁ are multiplied by n, frequency increase-or-decrease pulses e₀′ and e₁′ are multiplied by −n, and the results are summed. This processing is performed as follows. The two's complementer 144 inverts the sign of n to generate −n. A circuit which consists of leftward shifters 141a and 141b, logical product gates 142a and 142b, and selectors 145a and 145c shifts values n and −n leftward to generate values 2n and −2n, respectively when e₀=e₁=1 and e₀′=e₁′=1. Otherwise, selectors 145a and 145c output values n and −n, respectively.

A circuit which consist of logical sum gate 143a and selector 145b and a circuit which consists of logical sum gate 143b and selector 145d select the right-hand input of selectors 145b and 145d, respectively, to set the output of these circuits to 0 when e₀=e₁=0 and e₀′=e₁′=0. Otherwise, these circuits pass the outputs of selectors 145a and 145c to logical sum gate 146. One-adding circuit 147 and selector 145e provide one-subtracting circuit 148 and selector 145f with the output of the logical sum gate 146 with one added when frequency increase pulse f=1, otherwise with the output of logical sum gate 146. One-subtracting circuit 148 and selector 145f provide adder 149 with the output of selector 145e with one subtracted when frequency decrease pulse f′=1, otherwise with the output of selector 145e.

The output of selector 145f and that of register 150 are input to adder 149, and the output of adder 149 is returned to register 150. By the above-mentioned operation, adder 149 and register 150 perform accumulation of the value obtained by formula of n×(e₀+e₁−e₀′−e₁′)+f−f′ in synchronization with the rise of divided clock i, and the accumulation result is input to digital control oscillator 107 as control signal g.

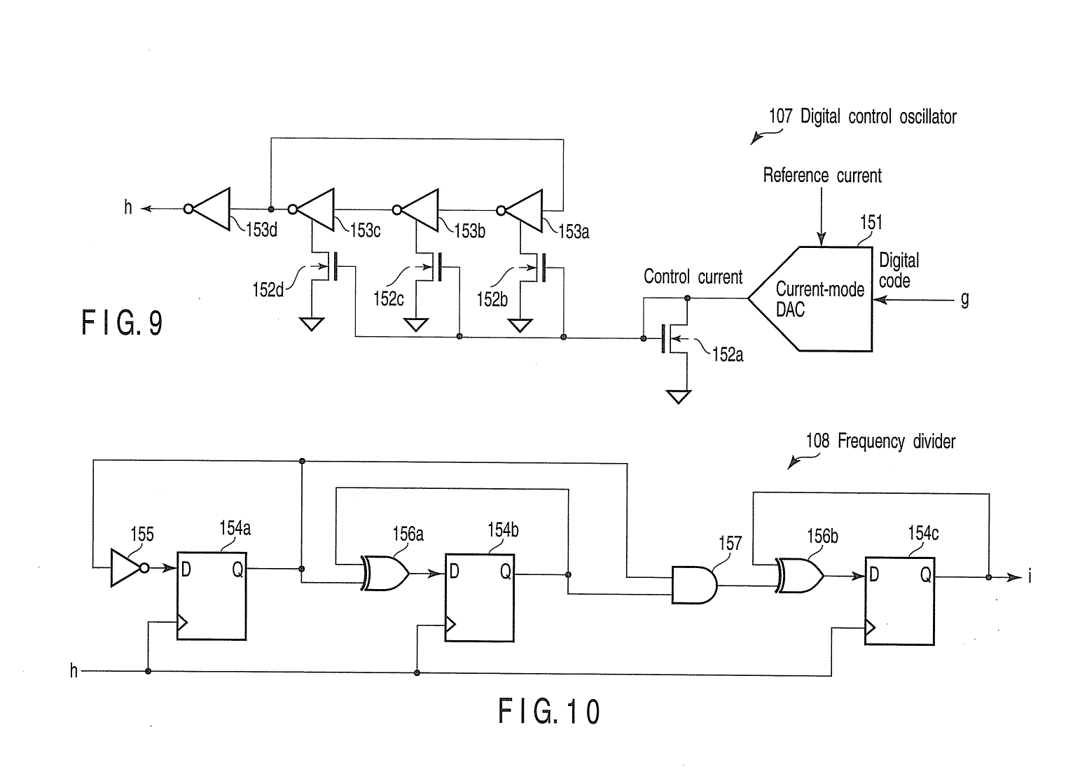

FIG. 9 shows an example of a specific circuit configuration of digital control oscillator 107 in CDR of FIG. 1. In FIG. 9, 151 is a current-mode digital analog converter (DAC), 152a-152d MOS transistors, and 153a-153d inverters. Standard current is input to DAC 151. DAC 151 outputs control current according to control signal (digital code) g. This control current flows into MOS transistor 152a. And the current proportional to the current which flows through MOS transistor 152a flows through MOS transistors 152b-152d, which constitute a current mirror circuit with MOS transistor 152a. Three inverters 153a-153c constitute an oscillating circuit. The current which flows through MOS transistors 152b-152d connected to inverters 153a-153c is controlled, which adjusts the oscillation frequency of the oscillator. Then, the waveform of the output of inverter 153c is formed by inverter 153d to generate reproduced clock h.

FIG. 10 shows an example of a specific circuit configuration of frequency divider 108 in CDR of FIG. 1. In FIG. 10, 154a-154c are D-type flip-flops, 155 an inverter, 156a and 156b exclusive OR gates, and 157 a logical product gate. Frequency divider 108 divides reproduced clock h by, for example, 8 in this example. Since such a frequency divider is well known, explanation on the operation is omitted.

In CDR which has the configuration of FIG. 1, providing frequency difference detection filter 105 can reduce the difference between the frequency of reproduced clock h and that of the clock contained in input data a to less than ±F_{S}/2. Therefore, when the absolute value of gap Δfb, which represents deviation of the clock frequency contained in received data from bit rate fb, is larger than F_{S}/2, it will be reduced to F_{S}/2.

As noted above, frequency offset represents the deviation of the clock frequency contained in received data from the defined communication rata (the bit rate), and is generally allowed to be hundreds ppm order. Here, assume that the frequency offset is ef, the bit rate fb, and the deviation Δfb of the clock frequency contained in received data, then frequency offset ef is given by the following formula (1).

ef=Δfb/fb (1)

Jitter tolerance JL, which refers to the maximum sine wave jitter amplitude that can transmit and receive data with a bit error below a specific one, and whose unit is UIp−p, of the conventional DLL type CDR disclosed in Jpn. Pat. Appln. KOKAI Publication No. 2005-64739 decreases as frequency offset ef increases, and is given by the following formula (2) in low frequency region.

JL=(fb/nfⱼ)[(dφ_{S}/N)−|{ef/(1+ef)}|](UIp−p) (2)

Here, fⱼ is the sine wave jitter's frequency, d the data transition density, φ_{S} the phase step width, and N the ratio of the operation clock frequency to the bit rate fb.

On the other hand, if it assumes that the oscillation frequency of PLL in CDR of the present embodiment is equal to fb in order to compare with the conventional DLL type CDR disclosed in Jpn. Pat. Appln. KOKAI Publication No. 2005-64739, the jitter tolerance of CDR can be expressed as the following formula (4) with φ_{S} of the formula (2) substituted by the formula (3).

φ_{S}=nF_{S}T_{D} (3)

JL=(fb/nfⱼ)[(dnF_{S}T_{D}/N)−|{ef′/(1+ef′)}|](UIp−p) (4)

Here, ef′ is as follows.

ef′=min{Δfb, F_{S}/2}/fb (5)

Formula (5) shows that designing F_{S}/2<Δfb reduces the influence of frequency offset more than prior art.

That is, since CDR of present embodiment can compress the frequency offset into half of the oscillation frequency change step F_{S} of digital control oscillator 108, its jitter tolerance improves. Note that it is assumed that the absolute value of the threshold of the jitter removal filter is equal to N-1 in the above calculation.

### Second Embodiment

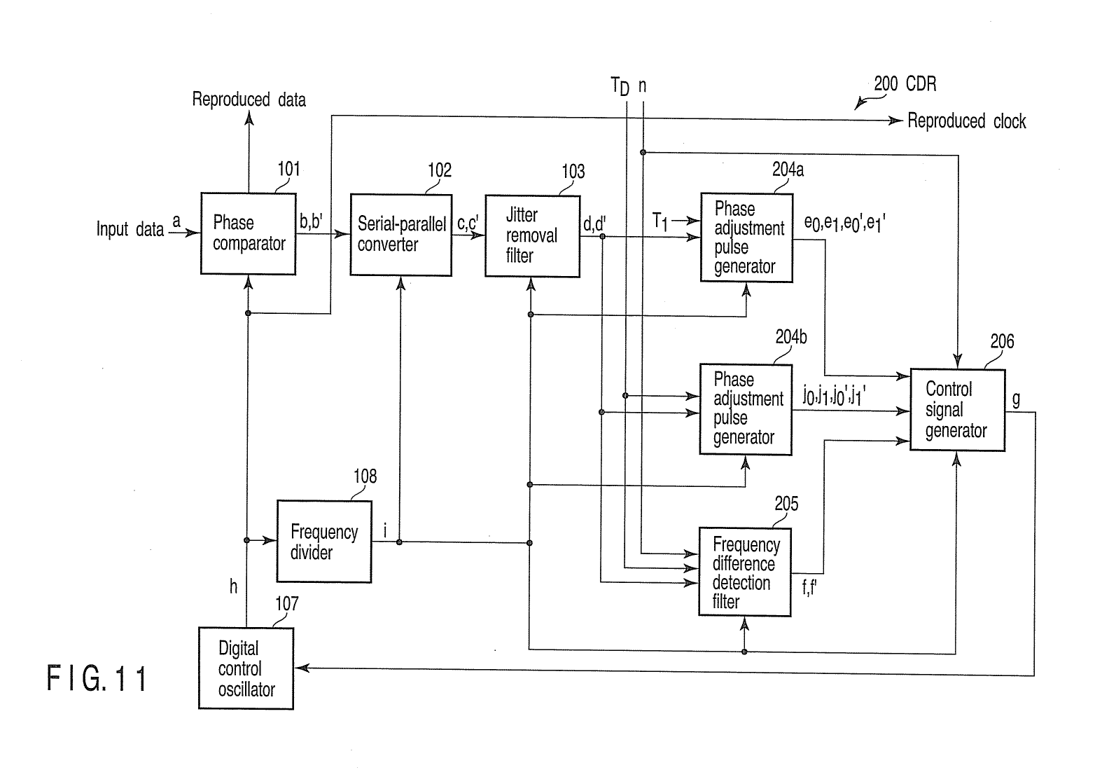

FIG. 11 is a block circuit diagram showing the configuration of CDR 200 according to the second embodiment of the present invention. Differences between CDR according to the present embodiment and that of the first embodiment shown in FIG. 1 are provision of phase adjustment pulse generator 204a and 204b instead of phase adjustment pulse generator 104, provision of frequency difference detection filter 205 instead of frequency difference detection filter 105, and provision of control signal generator 206 instead of control signal generator 106. Remaining parts are the same as those of FIG. 1, and explanation on them is omitted.

In the present embodiment, outputs d and d′ of jitter removal filter 103 are input to phase adjustment pulse generators 204a and 204b and frequency difference detection filter 205.

Frequency increase-or-decrease time width T₁ is input to phase adjustment pulse generator 204a as a control parameter. Frequency increase-or-decrease time width T₁ is equal to one cycle of divided clock i. Phase adjustment pulse generator 204a outputs frequency increase-or-decrease pulses e₀, e₁, e₀′, and e₁′. Frequency increase-or-decrease pulses e₀, e₁, e₀′, and e₁′ are used for increasing or decreasing the phase of reproduced clock h.

Frequency increase-or-decrease time width T_{D} is input to phase adjustment pulse generator 204b as a control parameter, and it outputs frequency increase-or-decrease pulses j₀, j₁, j₀′, and j₁′. Frequency increase-or-decrease pulses j₀, j₁, j₀′, and j₁′ are used for increasing or decreasing the phase of the reproduced clock h and used for compensating the frequency offset.

Among pulses output from phase adjustment pulse generators 204a and 204b, pulses e₀, e₁, j₀, and j₁ increase the oscillation frequency in digital control oscillator 107, and pulses e₀′, e₁′, j₀′, and j₁′ decrease it. That is, pulses e₀, e₁, j₀, and j₁ are frequency increase pulses, and pulses e₀′, e₁′, j₀′, and j₁′ are frequency decrease pulses.

When output d rises, phase adjustment pulse generator 204a sets pulse e₀ to 1 for one cycle of divided clock i. Then, phase adjustment pulse generator 204a sets pulse e₁′ to 1 for one cycle of divided clock i after elapse of period T₁ from the rise of output d. When output d rises again during period T₁, period T₁ starts from the last rising edge of output d. In the meantime, neither pulse e₀ nor e₁′ rises. Since the oscillation frequency is increased by the pulse e₀, and then, returned to the original value by the pulse e₁′, the phase of the reproduced clock h advances in proportion to the interval between rising edges of pulses e₀, and e₁′.

On the other hand, when output d′ rises, phase adjustment pulse generator 204a sets e₀′ to 1 for one cycle of divided clock i. Phase adjustment pulse generator 204a sets pulse e₁ to 1 for one cycle of divided clock i after elapse of period T₁ from the rise of output d′. When output d′ rises again during period T₁, period T₁ starts from the last rising edge of output d′. In the meantime, neither pulse e₀′ nor e₁ rises. Since the oscillation frequency is decreased by the pulse e₀′, and then, returned to the original value by the pulse e₁, the phase of the reproduced clock h delays in proportion to the interval between rising edges of pulses e₀′, and e₁.

When output d rises, phase adjustment pulse generator 204b sets pulse j₀ to 1 for one cycle of divided clock i. Then, phase adjustment pulse generator 204b sets pulse j₁′ to 1 for one cycle of divided clock i after elapse of period T_{D} from the rise of output d. When output d rises again during period T_{D}, period T_{D} starts from the last rising edge of output d. In the meantime, neither pulse j₀ nor j₁′ rises. Since the oscillation frequency is increased by the pulse j₀, and then, returned to the original value by the pulse j₁′, the phase of the reproduced clock h advances in proportion to the interval between rising edges of pulses j₀, and j₁′.

On the other hand, when output d′ rises, phase adjustment pulse generator 204b sets j₀′ to 1 for one cycle of divided clock i. Phase adjustment pulse generator 204b sets pulse j₁ to 1 for one cycle of divided clock i after elapse of period T_{D} from the rise of output d′. When output d′ rises again during period T_{D}, period T_{D} starts from the last rising edge of output d′. In the meantime, neither pulse j₀′ nor j₁ rises. Since the oscillation frequency is decreased by the pulse j₀′, and then, returned to the original value by the pulse j₁, the phase of the reproduced clock h delays in proportion to the interval between rising edges of pulses j₀′, and j₁.

Frequency increase-or-decrease step number n is input to control signal generator 206 as a control parameter. Control signal generator 206 multiplies frequency increase-or-decrease pulses e₀, e₁, e₀′, and e₁′ with frequency increase-or-decrease step number n, uses frequency increase-or-decrease pulses j₀, j₁, j₀′, and j₁′ and outputs f and f′ to perform an operation of [n×(e₀+e₁−e₀′−e₁′)]+(j₀+j₁−j₀′−j₁′)+f−f′, adds the operation result to output g which appeared one cycle before in divided clock i and is stored inside control signal generator 206, and stores the addition result as new signal g.

Frequency increase-or-decrease time width T_{D} and frequency increase-or-decrease step number n are input to frequency difference detection filter 205 as control parameters. Frequency difference detection filter 205 elongates outputs d and d′ to the same as period T_{D}, generates n-multiplied outputs d and d′, adds difference obtained by subtracting the elongated output d′ from the elongated output d and the difference obtained by subtracting the n-multiplied output d′ from n-multiplied output d, thereby reproduces the processing performed to pulses e₀, e₁, e₀′, and e₁′ and pulses j₀, j₁, j₀′, and j₁′ inside control signal generator 206. Moreover, frequency difference detection filter 205 accumulates the addition result for a predetermined period and compares the accumulation result with a positive and negative thresholds, thereby determines whether the increment of the average frequency of input data is equal to or more than half the minimum change width F_{S} of the oscillation frequency of digital control oscillator 107. Frequency difference detection filter 205 sets output f to 1 for one period of divided clock i when the sign of the increment is positive, or sets output f′ to 1 for one period of divided clock i when the sign of the increment is negative, thereby increases or decreases the oscillation frequency of digital control oscillator 107 by F_{S}. Output g of control signal generator 206 is input to digital control oscillator 107, and controls the frequency of output h of digital control oscillator 107.

CDR of FIG. 11 is reset by a reset circuit (not shown) so that the oscillation frequency of digital control oscillator 107 has a frequency f0 sufficiently near the bit rate.

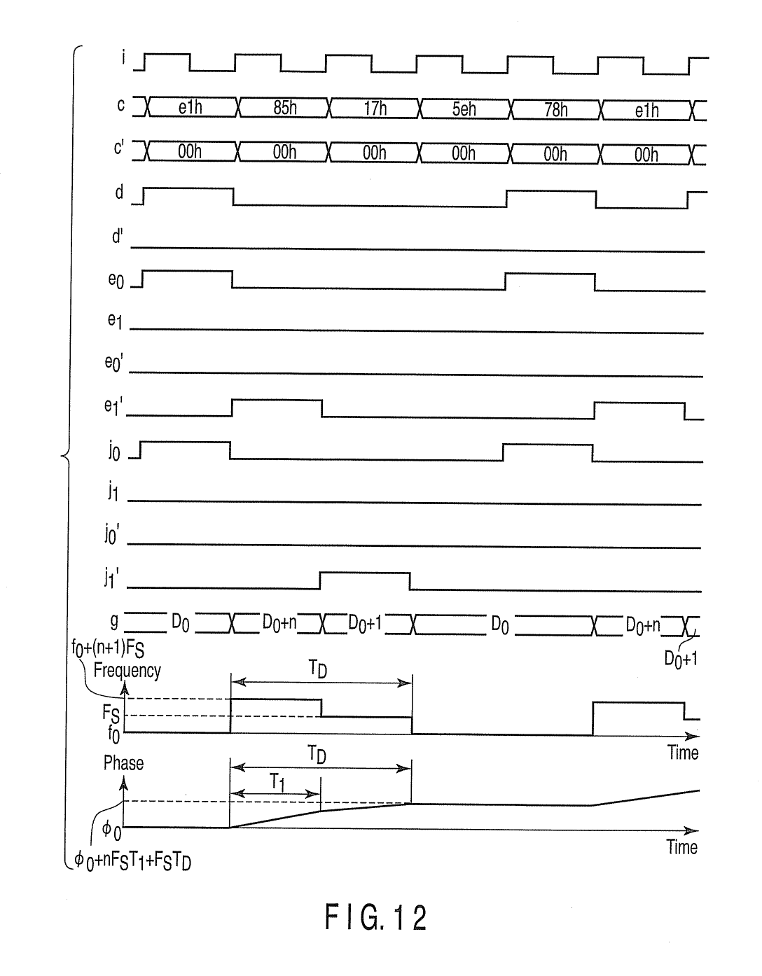

FIG. 12 is a timing chart which shows an example of operation of CDR shown in FIG. 11. FIG. 12 shows the case where the phase of reproduced clock h always delays to the transmission clock (more specifically, the center of each bit section of data) contained in the data of input data a.

In FIG. 12, unlike FIG. 2, the oscillation frequency of digital control oscillator 107 is (n+1)F_{S} during period T₁ and, then, decreases to F_{S} during period T_{D}−T₁, exhibiting a step-like decline. The phase of reproduced clock h changes by inclination (n+1)F_{S} during period T₁ and by inclination F_{S} during period T_{D}−T₁. The amount of change of the phase is expressed with nF_{S}T₁+F_{S}T_{D}. The phase of reproduced clock h keeps changing with frequency f₀ of digital control oscillator 107 after reset release. As in FIG. 2, the phase which changes with f₀ is assumed to be φ₀, and the deviation from this standard phase is shown as the phase of reproduced clock h.

Among circuit blocks which constitute CDR 200 of the second embodiment, those other than frequency difference detection filter 205 and control signal generator 206 have the same configurations as those of CDR 100 of the first embodiment. Specifically, phase comparator 101 can have the configuration shown in FIG. 3, serial-parallel converter 102 can have the configuration shown in FIG. 4, jitter removal filter 103 can have the configuration shown in FIG. 5, phase adjustment pulse generators 204a and 204b can have the configuration shown in FIG. 6, digital control oscillator 107 can have the configuration shown in FIG. 9, and frequency divider 108 can have the configuration shown in FIG. 10. In FIG. 6, frequency increase-or-decrease pluses j₀, j₁, j₀′, and j₁′, which are output from phase adjustment pulse generator 204b in the second embodiment and are shown in addition to frequency increase-or-decrease pluses e₀, e₁, e₀′, and e₁′, which are output from phase adjustment pulse generator 104 in the first embodiment and phase adjustment pulse generator 204a in the second embodiment. For phase adjustment pulse generator 204a, it is provided with T₁ instead of T_{D} of FIG. 6.

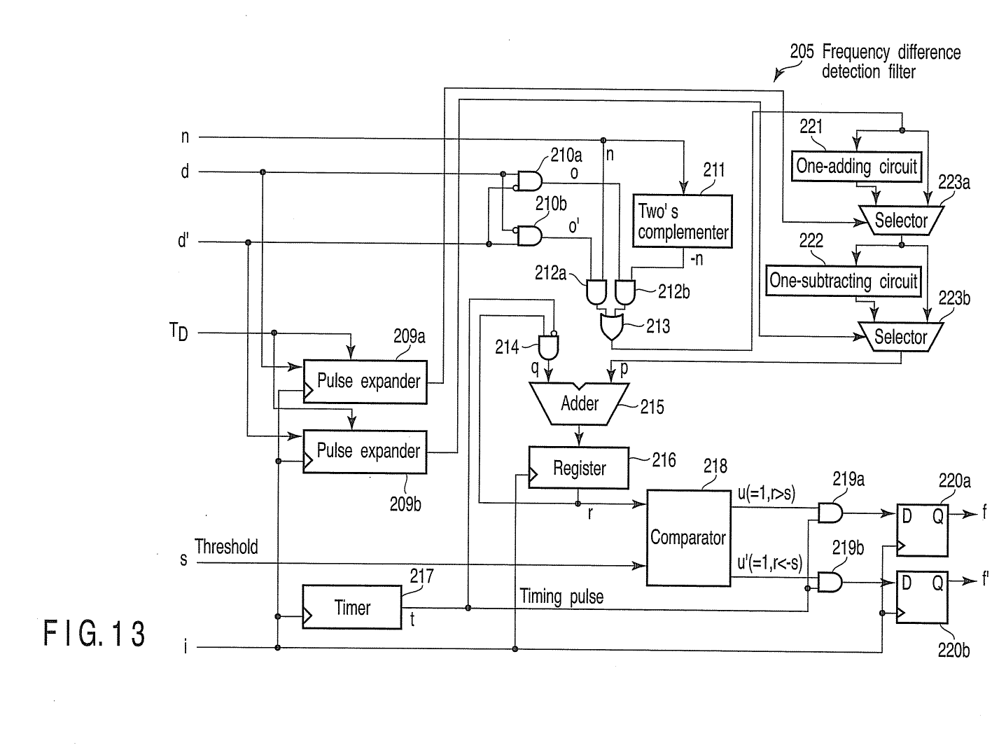

FIG. 13 shows an example of a specific circuit configuration of frequency difference detection filter 205 in CDR of FIG. 11. In FIG. 13, 209a and 209b are pulse expanders, 210a, 210b, 219a, and 219b logical product gates, 211 a two′ complementer, 212a, 212b, and 214 are logical product gates (multiple bits), 213 a logical sum gate (multiple bits), 215 an adder, 216 a register, 217 a timer, 218 a comparator, 220a and 220b D-type flip-flops, 221 one-adding circuit, 222 one-subtracting circuit, and 223a and 223b selectors.

In the frequency difference detection filter 205 shown in FIG. 13, unlike frequency difference detection filter 105 shown in FIG. 7, outputs o and o′ of logical product gates 210a and 210b are directly generated from outputs d and d′ of jitter removal filter 103, respectively. Moreover, multiplication of outputs o and o′ by respective frequency increase-or-decrease step numbers n and −n is performed by two's complementer 211, multiple-bits logical product gates 212a and 212b, and logical sum gate 213, like frequency difference detection filter 105 shown in FIG. 7. In frequency difference detection filter 205, outputs d and d′ are input to pulse expanders 209a and 209b, respectively, to be extended to have the same period as period T_{D}, and the extended d and d′ are input to selectors 223a and 223b as control inputs. Selector 223a selects the input or output of one-adding circuit 221. Selector 223b selects the input or output of one-subtracting circuit 222. The output of logical sum gate 213 is supplied to one-adding circuit 221 and selector 223a. The output of selector 223a is supplied to one-subtracting circuit 222 and selector 223b. Output p of selector 223b is input to one input of adder 215. Functions of signals p, q, r, s, t, u, u′, f, f′ in FIG. 13 are identical to those of frequency difference detection filter 105 of FIG. 7. Therefore, explanation on them is omitted.

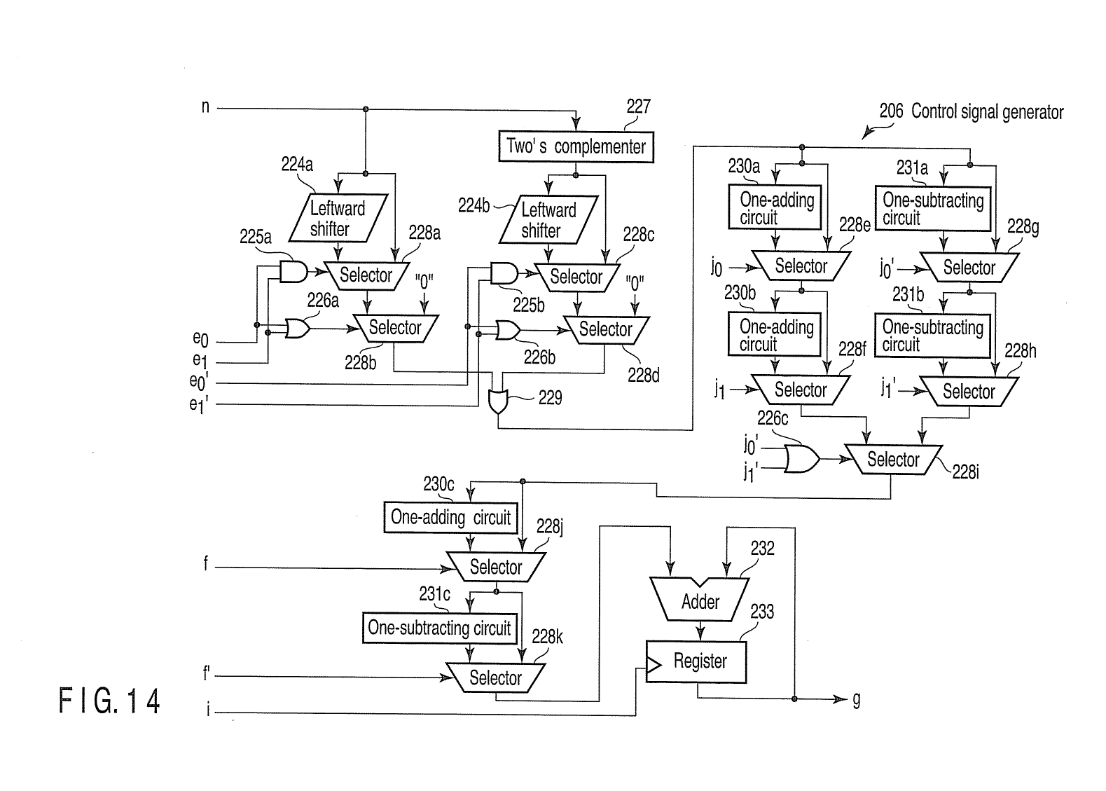

FIG. 14 shows an example of a specific circuit configuration of control signal generator 206 in CDR of FIG. 11. In FIG. 14, 224a and 224b are leftward shifter, 225a and 225b logical product gates, 226a-226c logical sum gates, 227 a two′ complementer, 228a-228k selectors, 229 a logical sum gate (multiple bits), 230a-230c one-adding circuits, 231a-231c one-subtracting circuits, 232 an adder, and 233 a register.

Control signal generator 206 includes control signal generator shown in FIG. 8 with addition of a circuit which receives pulses j₀, j₁, j₀′, and j₁′ shown in the upper-left portion of FIG. 14. The circuit consists of two selectively-one-adding circuits each of which consists of one-adding circuits 230a and 230b and selectors 228e and 228f, respectively, two selectively-one-subtracting circuits each of which consists of one-subtracting circuits 231a and 231b and selectors 228g and 228h, respectively, logical sum gates 226c, and selectors 228i. The two selectively-one-adding circuits are connected in series. The two selectively-one-subtracting circuits are connected in series and in parallel with the serially-connected two selectively-one-adding circuits.

Each of selectively-one-adding circuits adds one to the output of logical sum gate 229 when pulse j₀ and j₁ are 1. Each of selectively-one-subtracting circuits subtracts one from the output of logical sum gate 229 when pulses j₀′ and j₁′ are 1. The output of the subsequent one of the selectively-one-adding circuits (the output of selector 228f) and that of the subsequent one of the selectively-one-subtracting circuits (the output of selector 228h) are supplied to selector 228i. Selector 228i and logical sum gate 226c select the output of the subsequent one of the selectively-one-adding circuits when pulses j₀′ and/or j₁′ are 1, otherwise they select the output of the subsequent one of the selectively-one-subtracting circuits. The selected output is input to one-adding circuit 230c and selector 228j.

One-adding circuit 230c, one-subtracting circuit 231c, selectors 228j and 228k, adder 232, and register 233 function similarly to one-adding circuit 147, one-subtracting circuit 148, selectors 145e and 145f, adder 149, and register 150 of control signal generator 106 shown in FIG. 8, respectively. Therefore, output g of control signal generator 206 is accumulation of [n×(e₀+e₁−e₀′−e₁′)]+(j₀+j₁−j₀′−j₁′)+f−f′.

In CDR of the first embodiment, the amount of phase change equivalent to the DLL type is φ_{S}=nF_{S}T_{D} as it is expressed by formula (3). When the value is small, the performance of tracking to the phase change deteriorates and the jitter tolerance in a low frequency region deteriorates. However, when it is too large, the jitter tolerance in a high frequency region deteriorates because the fluctuation of the amount is added to the clock from CDR. Therefore, φ_{S} needs to be adjusted. However, since the frequency step is multiplied by the product of control parameters n and T_{D} in (3) formula, the flexibility in selecting these parameters is restricted.

In CDR of the second embodiment shown in FIG. 11, φ_{S} is given by the following (6) formula.

φ_{S}=nF_{S}T₁+F_{S}T_{D} (6)

Here, T₁ is one cycle of divided clock i.

Since control parameters n and T_{D} are coupled by addition in formula (6), which can increase the flexibility in selecting these parameters and keep the jitter tolerance at appropriate level for all frequencies.

As mentioned above, when output d (or d′) is again set to 1 during periods T_{D}, the length of the frequency change pulse is extended to be longer than T_{D}. Since frequency offset can be designed to be F_{S}/2 according to the present system, the influence by this can be absorbed by the second clause of formula (6). Then, the first clause can be chosen in accordance with expected jitter amplitude regardless of the frequency offset.

That is, CDR according to the second embodiment can offer advantage that phase adjustment width can be controlled more finely than the first embodiment.

### Third Embodiment

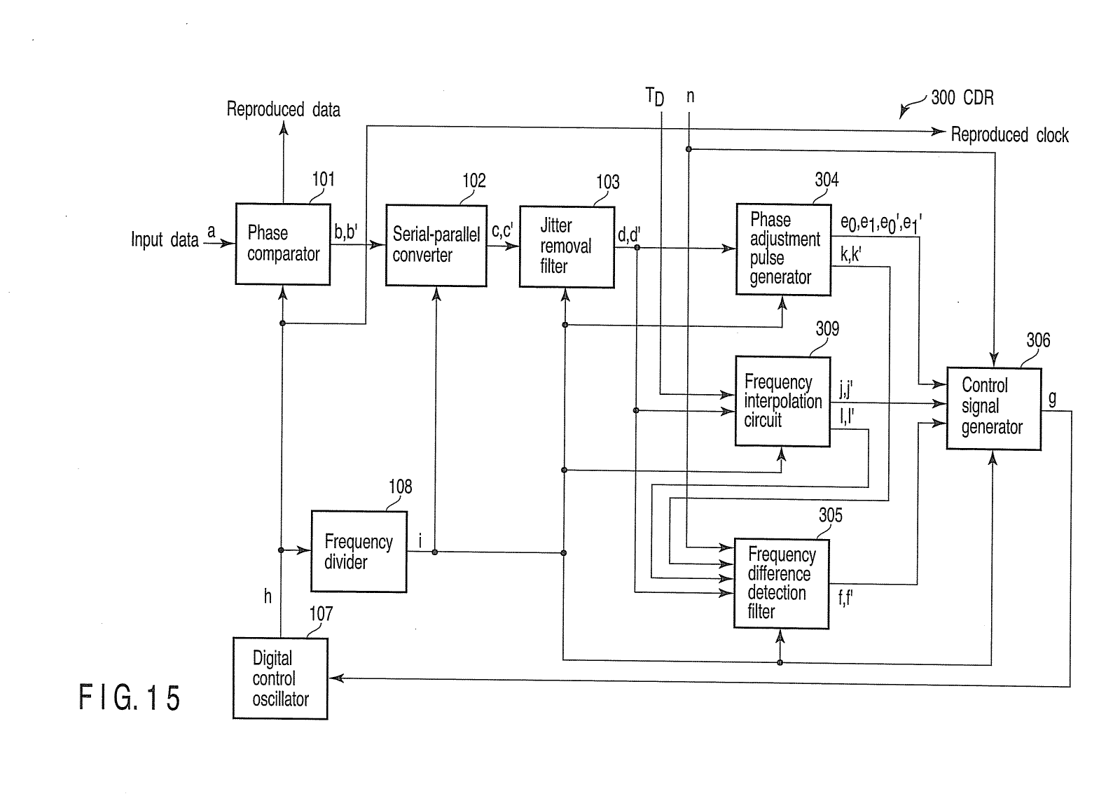

FIG. 15 is a block circuit diagram showing the configuration of CDR 300 according to the third embodiment of the present invention. Differences between CDR according to the present embodiment and that of the first embodiment shown in FIG. 1 are provision of phase adjustment pulse generator 304 instead of phase adjustment pulse generator 104, provision of frequency difference detection filter 305 instead of frequency difference detection filter 105, provision of frequency interpolation circuit 309, and provision of control signal generator 306 instead of control signal generator 106.

In the present embodiment, outputs d and d′ of jitter removal filter 103 are input to phase adjustment pulse generator 304, frequency difference detection filter 305, and frequency interpolation circuit 309.

Frequency increase-or-decrease time width T₁ shown in FIG. 11 is not input to phase adjustment pulse generator 304. However, since the frequency increase-or-decrease time width T₁ is equivalent to one cycle of divided clock i, it is generated using a memory circuit (for example, D-type flip-flops 310a and 310b) inside phase adjustment pulse generator 304. That is, T₁ is designed as a fixed parameter. Of course, T₁ can also be variable. Phase adjustment pulse generator 304 outputs frequency increase-or-decrease pulses e₀, e₁, e₀′, and e₁′, and state signals k and k′, which indicate whether it is in state for increasing or decreasing the frequency. Frequency increase-or-decrease pulses e₀, e₁, e₀′, and e₁′ are used for increasing or decreasing the phase of reproduced clock h.

Frequency increase-or-decrease time width T_{D} is input to frequency interpolation circuit 309 as a control parameter. Frequency interpolation circuit 309 outputs frequency increase-or-decrease pulses j and j′ 0 and state signals l and l′, which indicate whether it is in state for increasing or decreasing the frequency. Pulses e₀, e₁, and j increase the oscillation frequency in digital control oscillator 107, and, on the contrary, pulse e₀′, e₁′, and j′ decrease it. That is, pulses e₀, e₁, and j are frequency increase pulses, and pulses e_{0′, e}₁′, and j′ are frequency decrease pulses.

When output d rises, phase adjustment pulse generator 304 sets pulse e₀ to 1 for one cycle of divided clock i. Then, phase adjustment pulse generator 304 sets pulse e₁′ to 1 for one cycle of divided clock i after elapse of period T₁ from the rise of output d. When output d rises again during period T₁, period T_{D} starts from the last rising edge of output d. In the meantime, neither pulse e₀ nor e₁′ rises. Since the oscillation frequency is increased by the pulse e₀, and then, returned to the original value by the pulse e₁′, the phase of the reproduced clock h advances in proportion to the interval between rising edges of pulses e₀, and e₁′.

On the other hand, when output d′ rises, phase adjustment pulse generator 304 sets e₀′ to 1 for one cycle of divided clock i. Phase adjustment pulse generator 304 sets pulse e₁ to 1 for one cycle of divided clock i after elapse of period T₁ from the rise of output d′. When output d′ rises again during period T₁, period T₁ starts from the last rising edge of output d′. In the meantime, neither pulse e₀′ nor e₁ rises. Since the oscillation frequency is decreased by the pulse e₀′, and then, returned to the original value by the pulse e₁, the phase of the reproduced clock h delays in proportion to the interval between rising edges of pulses e₀′, and e₁. State signals k and k′ are outputs of the internal memory circuits which store that outputs d and d′ has risen, respectively, and indicate whether it is in state for increasing or decreasing the frequency.

When output d rises, frequency interpolation circuit 309 sets pulse j to 1 for one cycle of divided clock i. Then, frequency interpolation circuit 309 sets pulse j′ to 1 for one cycle of divided clock i after elapse of period T_{D} from the rise of output d. When output d rises again during period T_{D}, period T_{D} starts from the last rising edge of output d. In the meantime, neither pulse j nor j′ rises.

On the other hand, when output d′ rises, frequency interpolation circuit 309 sets pulse j0′ to 1 for one cycle of divided clock i. Then, frequency interpolation circuit 309 sets pulse j to 1 for one cycle of divided clock i after elapse of period TD from the rise of output d′. When output d′ rises again during period TD, period TD starts from the last rising edge of output d′. In the meantime, neither pulse j′ nor j rises. The case where signal d or d′ of the opposite direction rises during period T_{D} is explained later.

In other words and in summary, frequency interpolation circuit 309 has a memory circuit which stores outputs d and d′ of jitter removal filter, and generates frequency increase-or-decrease pulses f and f′ for compensating the frequency offset from outputs d and d′ of jitter removal filter and the output of the memory circuit to.

Frequency increase-or-decrease step number n is input to control signal generator 306 as a control parameter. Control signal generator 306 multiplies frequency increase-or-decrease pulses e₀, e₁, e₀′, and e₁′ by frequency increase-or-decrease step number n, uses frequency increase-or-decrease pulses j and j′ and outputs f and f′ to perform an operation of [n×(e₀+e₁−e₀′−e₁′)]+(j+j′)+f−f′, adds the operation result to output g which appeared one cycle before in divided clock i and is stored inside control signal generator 306, and stores the addition result as new signal g.

Frequency increase-or-decrease step number n is input to frequency difference detection filter 305 as a control parameter. Frequency difference detection filter 305 adds the difference obtained by subtracting n-multiplied state signal k′ from n-multiplied state signal k and the difference obtained by subtracting state signal l′ from state signal l, thereby reproduces the processing performed to pulses e₀, e₁, e₀′, and e₁′ and pulses j and j′ inside control signal generator 306. Moreover, frequency difference detection filter 305 accumulates the addition result for a predetermined period and compares the accumulation result with a positive and negative thresholds, thereby determines whether the increment of the average frequency of input data is equal to or more than half the minimum change width F_{S} of the oscillation frequency of digital control oscillator 107. Frequency difference detection filter 305 sets output f to 1 for one period of divided clock i when the sign of the increment is positive, or sets output f′ to 1 for one period of divided clock i when the sign of the increment is negative, thereby increases or decreases the oscillation frequency of digital control oscillator 107 by F_{S}. Output g of control signal generator 306 is input to digital control oscillator 107, and controls the frequency of output h of digital control oscillator 107.

In other words and in summary, frequency difference detection filter 305 accumulates output of the internal memory circuit of phase adjustment pulse generator 304 and that of the memory circuit of frequency interpolation circuit 309 to detect difference between reproduced clock h and the average frequency of input data sequence, and generates frequency increase-or-decrease pulses f and f′ for correcting the difference.

CDR of FIG. 15 is reset by a reset circuit (not shown) so that the oscillation frequency of digital control oscillator 107 has a frequency f₀ sufficiently near the bit rate.

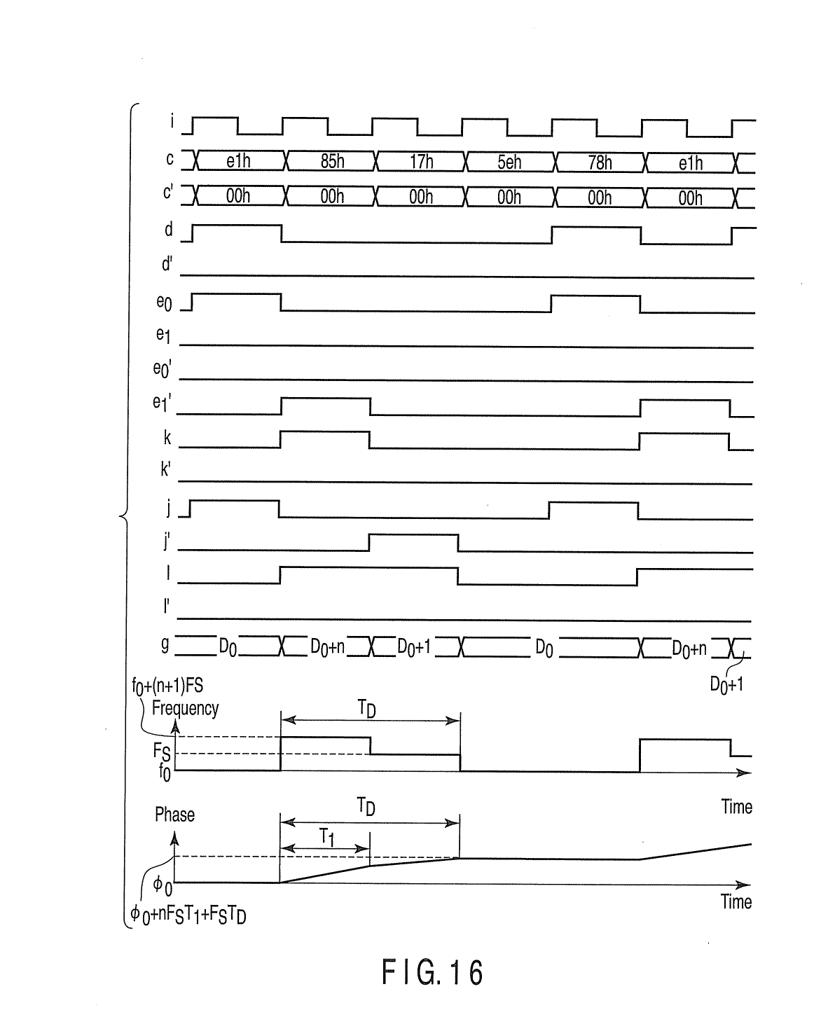

FIG. 16 is a timing chart which shows an example of operation of CDR shown in FIG. 15. FIG. 16 shows the case where the phase of reproduced clock h always delays to the transmission clock (more specifically, the center of each bit section of data) contained in the data of input data a.

In FIG. 16, as in FIG. 12, the oscillation frequency of digital control oscillator 107 is (n+1) F_{S} during period T1 and, then, decreases to F_{S} during period TD−T1, exhibiting a step-like decline. The phase of reproduced clock h changes by inclination (n+1)FS during period T1 and by inclination FS during period TD−T1. The amount of change of the phase is expressed with nFST1+FSTD. The phase of reproduced clock h keeps changing with the frequency f0 of digital control oscillator 107 after reset release. As in FIG. 2 or FIG. 12, the phase which changes with f0 is assumed to be φ0, and the deviation from this standard phase is shown as the phase of reproduced clock h.

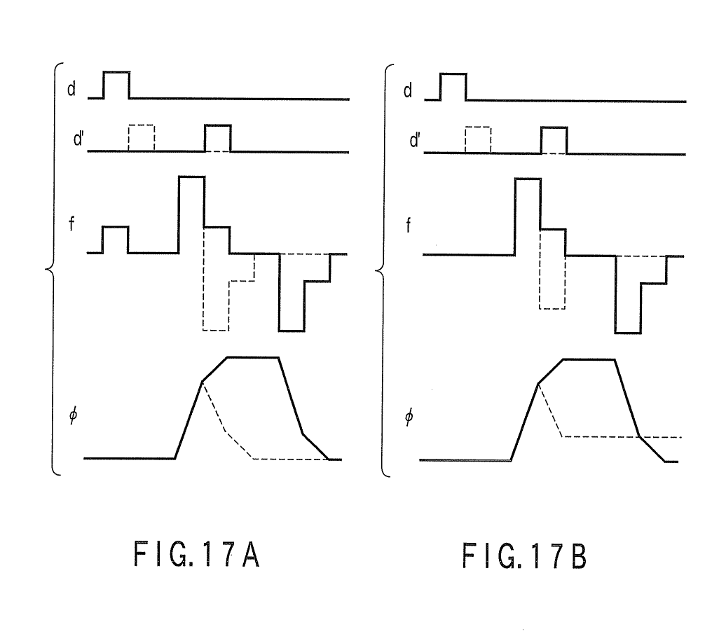

FIGS. 17A and 17B are timing charts which show the difference in operation of CDR 200 of the second embodiment shown in FIG. 11 and CDR 300 of the third embodiment shown in FIG. 15. FIG. 17A is for the second embodiment, and FIG. 17B is for the third embodiment.

Example is shown in which signals d and d′ which change the frequency in opposite directions are successively output from jitter removal filter 103 with a specific interval. If the interval is longer than period T_{D}, phase φ of reproduced clock h in each embodiment exhibits the same behavior as shown by the solid line in FIG. 17A and FIG. 17B.

However, they behave differently when the interval is shorter than period T_{D}. More specifically, the phase φ of reproduced clock h returns to its original state in the second embodiment shown in FIG. 17A, while it decreases by only nF_{S}T₁ in the third embodiment shown in FIG. 17B. This phenomenon is especially remarkable when period T_{D} is infinite. When period T_{D} is infinite, frequency interpolation circuit 309 switches oscillation frequency of digital control oscillator 107 to f or f+F_{S} (or f−F_{S}) according to time so that their average approaches to the average of the clock frequency contained in input data. The reason for making period T_{D} limited is that operation of CDR contains probability factor, and the phase error caused by frequency interpolation increases or decreases especially depending on the data transition probability. Typical phase comparators used in CDR can detect phase difference only when data changes. With limited period T_{D}, frequency which has changed returns to its original position after elapse of a fixed period, even if data has not changed, so that accumulation of the phase error due to difference deviation can be prevented.

Among circuit blocks which constitute CDR 300 of the third embodiment, those other than phase adjustment pulse generator 304, frequency difference detection filter 305, control signal generator 306, and frequency interpolation circuit 309 have the same configuration as that of CDR of the first and second embodiments.

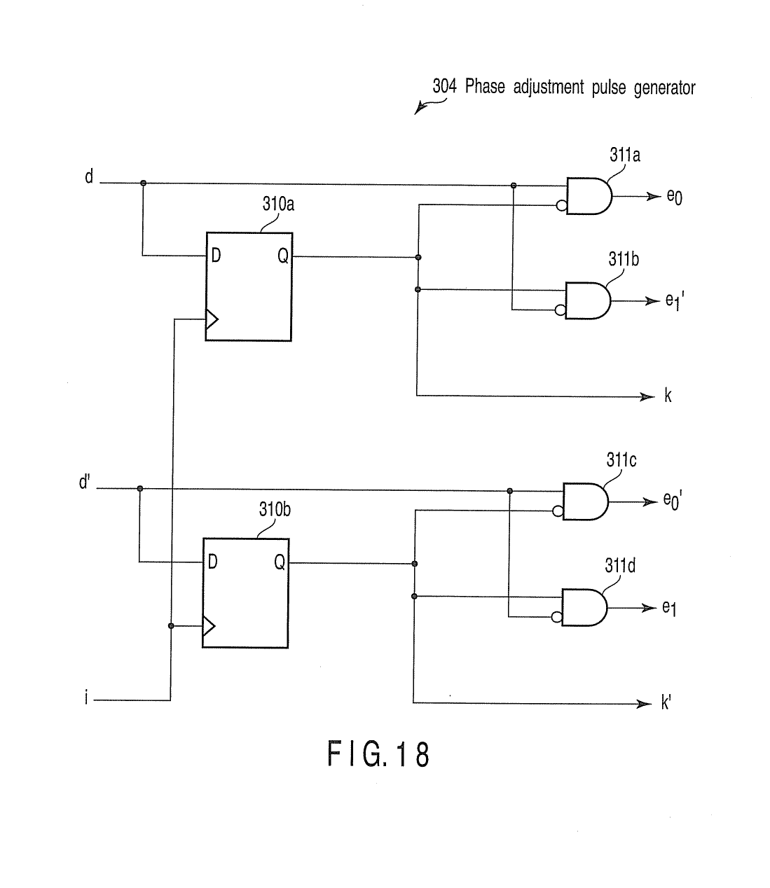

FIG. 18 shows an example of a specific circuit configuration of phase adjustment pulse generator 304 in CDR of FIG. 15. In FIG. 18, 310a and 310b are D-type flip-flops, and 311a-311d logical product gates. Flip-flop 310a stores output d of jitter removal filter 103 in synchronization with divided clock i. Logical product gates 311a and 311b produce logical product of output d of jitter removal filter 103 and the output of flip-flop 310a, and output frequency increase-or-decrease pulses e₀ and e₁′, respectively. State signal k is taken as the output of flip-flop 310a. Flip-flop 310b stores output d′ of jitter removal filter 103 in synchronization with divided clock i. Logical product gates 311c and 311d produce the logical product of output d′ of jitter removal filter 103 and the output flip-flop 310b, and output frequency increase-or-decrease pulses e₀′ and e₁, respectively. State signal k′ is taken as the output of flip-flop 310b.

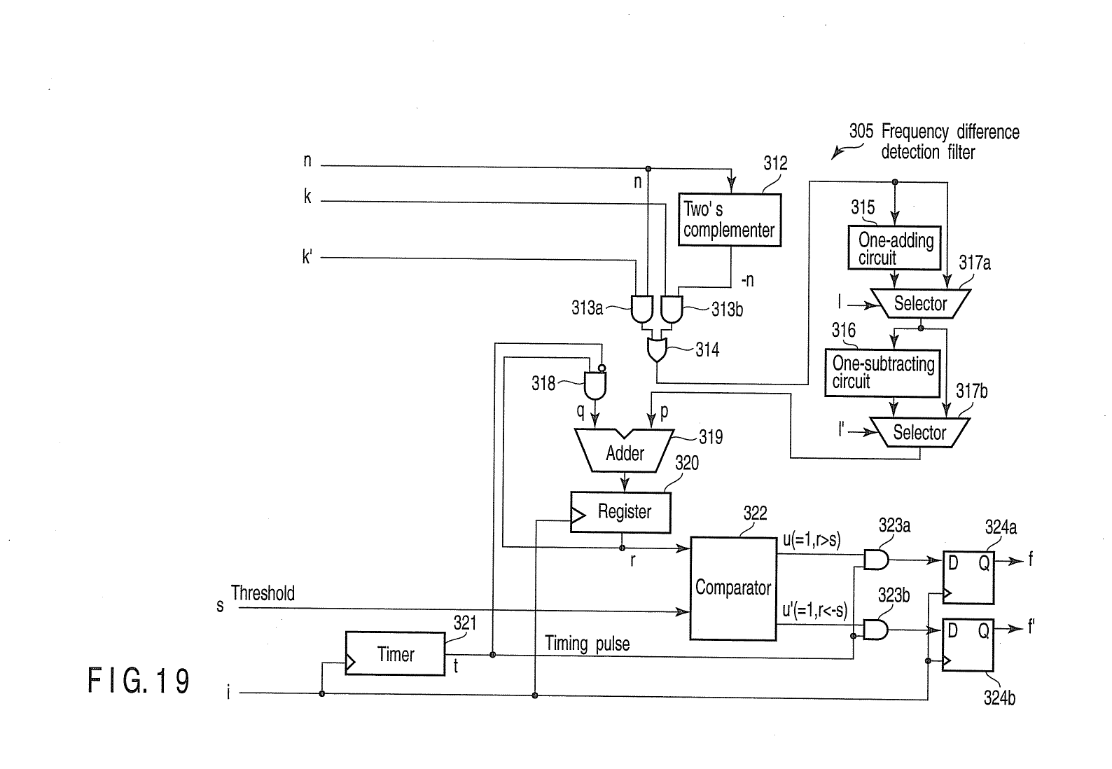

FIG. 19 shows an example of a specific circuit configuration of frequency difference detection filter 305 in CDR of FIG. 15. In FIG. 19, 312 is a two's complementer, 313a, 313b, 318 logical product gates (multiple bits), 314 a logical sum gate (multiple bits), 315 one-adding circuit, 316 one-subtracting circuit, 317a and 317b selectors, 319 an adder, 320 a register, 321 a timer, 322 a comparator, 323a and 323b logical product gates, and 324a and 324b D-type flip-flops.

The frequency difference detection filter 305 shown in FIG. 19 does not need pulse expanders, such as frequency difference detection filter 105 shown in FIG. 7 or frequency difference detection filter 205 shown in FIG. 13, because it detects a frequency difference using inputs k, k′, l, and l′. Inputs k and k′ are obtained by delaying outputs d and d′ by one cycle of divided clock i, respectively. Since inputs k and k′ are the rise and fall signals which are output from jitter removal filter 103, they are not simultaneously set to 1. For this reason, inputs k and k′ are input to logical product gates 313a and 313b, respectively, in FIG. 19, and they serve for selection control variable n representing the number of steps or its sign-inverted version (−n) produced by two′ complementer 312.

The logical sum gate 314 receives outputs of logical product gates 313a and 313b, outputs 0 when k=k′, outputs n when k=1 and k′=0, and outputs −n when k=0 and k′=1. The output of logical sum gate 314 is input to one-adding circuit 315 and one input of selector 317a. Selector 317a outputs the output of one-adding circuit when input k=1, and outputs the output of logical sum gate 314 when l=0. The output of selector 317a is input to one-subtracting circuit 316 and selector 317b. Selector 317b outputs the output of one-subtracting circuit when input l′=1, and outputs the output of selector 317a when l′=0. For this reason, the output p of selector 317b is p=n×(k−k′)+l−l′. Functions of signals p, q, r, s, t, u, u′, f, f′ shown in FIG. 19 are the same as those in frequency difference detection filter 105 or 205 in the preceding embodiments. Therefore, explanation on them is omitted.

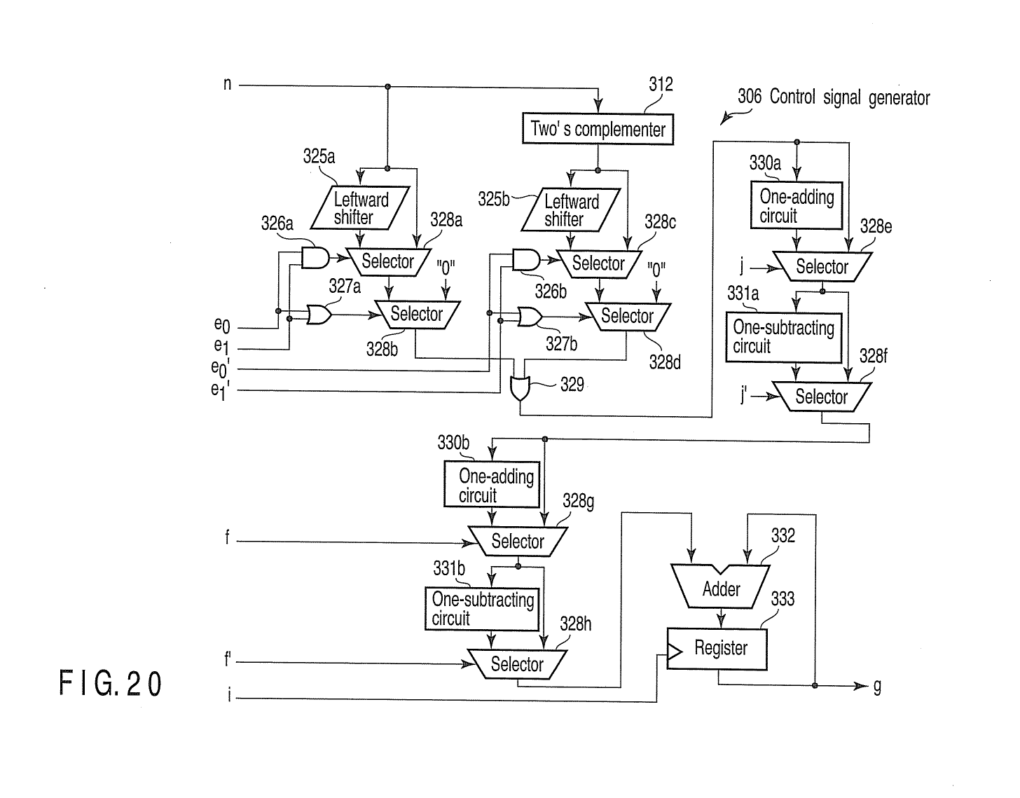

FIG. 20 shows an example of a specific circuit configuration of control signal generator 306 in CDR of FIG. 15. In FIG. 20, 312 is a two′ complementer, 325a and 325b leftward shifters, 326a and 326b logical product gates, 327a and 327b logical sum gates, 328a-328h selectors, 329 a logical sum gate (multiple bits), 330a and 330b one-adding circuits, 331a and 331b one-subtracting circuits, 332 an adder, and 333 a register.

The control signal generator 306 shown in FIG. 20 is control signal generator 206 which replaces a circuit receiving pulses j₀, j₁, j₀′, and j₁′, i.e., a circuit consisting of logical sum gate 226c, selectors 228e-228i, one-adding circuits 230a and 230b, and one-subtracting circuits 231a and 231b with a circuit receiving pulses j and j′, i.e., a circuit consisting of one-adding circuit 330a, one-subtracting circuit 331a, and selectors 328e and 328f. In the circuit of FIG. 20, since inputs j₀, j₁, j₀′, and j₁′ of the circuit of FIG. 14 are replaced with pulses j and j′, Signal g is accumulation of [n×(e₀+e₁−e₀′−e₁′)]+(j−j′)+f−f₁.

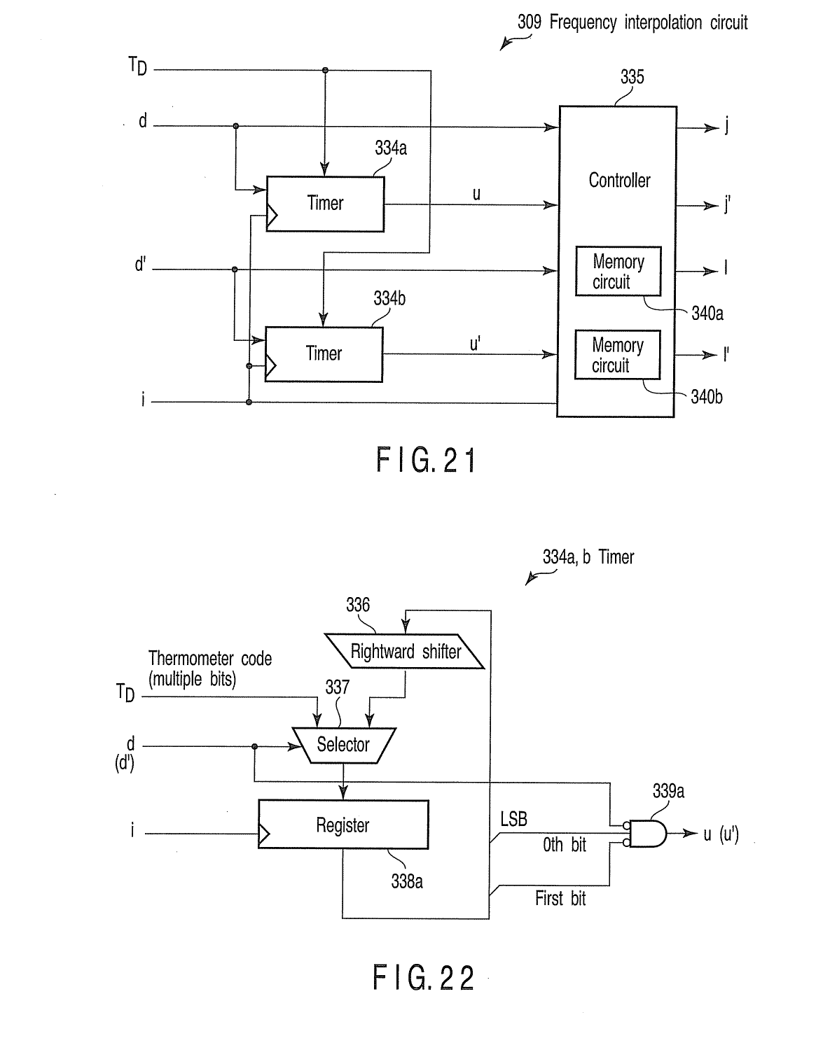

FIG. 21 shows an example of a specific circuit configuration of frequency interpolation circuit 309 in CDR of FIG. 15. In FIG. 21, 334a and 334b are timers, and 335 a control circuit.

The control circuit 335 takes three internal states and is a state machine which makes transition among the states according to the value of d and d′. The state is expressed with state variable l and l′, and control circuit 335 has two memory circuits (for example, D-type flip-flop) 340a and 340b which store state variable l and l′, respectively. State variable l and l′ are output outside. One of the states is the initial state of l=l′=0. It takes the state of l=1 and l′=0 when the internal state is in the initial state and pulses d and d′ are set to d=1 and d′=0. This indicates that the frequency has increased by one step. The state of l=1 and l′=0 does not change, even if pulses d=1 and d′=0 are further input, and the frequency does not increase by more than one step. When d=0 and d′=1 are input in this state, the internal state returns to the initial state.

On the other hand, the internal state takes the state of l=0 and l′=1 when the internal state is in the initial state and pulses d and d′ are set to d=0 and d′=1. This indicates that the frequency has decreased by one step. The state of l=0 and l′=1 does not change, even if pulses d=0 and d′=1 are further input, and the frequency does not decrease by more than one step. When d=1 and d′=0 are input in this state, the internal state returns to the initial state. With such operation, oscillation frequency of digital control oscillator 107 fluctuates within the rage of ±F_{S} to allow the frequency offset with changed pulse width to be interpolated. Note that d=d′=1 never occurs due to the principle of jitter removal filter 103.

Two timers 334a and 334b in FIG. 21 are for limiting periods for which the internal state remains at state of l=1 and l′=0, and l=0 and l′=1 to width T_{D}. However, when there are again inputs which change the internal state from the initial state to these two states during period T_{D}, the internal state does not return to the initial state because the T_{D} starts at the input reception.

FIG. 22 shows an example of a specific circuit configuration of the timers 334a and 334b in frequency interpolation circuit 309 shown in FIG. 21. In FIG. 22, 336 is a rightward shifter, 337 a selector, 338 a register, and 339 a logical product gate.

The timer shown in FIG. 22 is for limiting period for which the internal state of frequency interpolation circuit 309 shown in FIG. 21 remains, and for realizing frequency change width T_{D} shown in FIG. 16. This operation is realized by representing T_{D} by a thermometer code, which represents a value by the number of consecutive bit “1” from the least significant bit (LSB). When signal d (or d′) is 1, selector 337 selects a left-hand input, and value TD is loaded to register 338. This value is shifted rightward by one bit by rightward shifter 336, and is returned to the right-hand input of selector 337. For this reason, when d (or d′)=0, the data in register 338 is shifted rightward in synchronization with the rise of divided clock i.

The logical product gate 339a sets output u (or u′) to 1, when it detects that register 338 is a state just before all its bits are 0, i.e., that its lowest two bits are 01. Since all the bits of register 338 are set to 0 in the following clock cycle, states of output u (or u′)=1 keeps for only one cycle. As a result, the internal state returns to the initial state, and when again d (or d′)=1, the above-mentioned operation is repeated. When d (or d′)=1 while the bit of one remains in register 338, output u (or u′) does not rise, value T_{D} is loaded to register 338, and the shifting starts and time T_{D} starts upon d (or d′)=0.

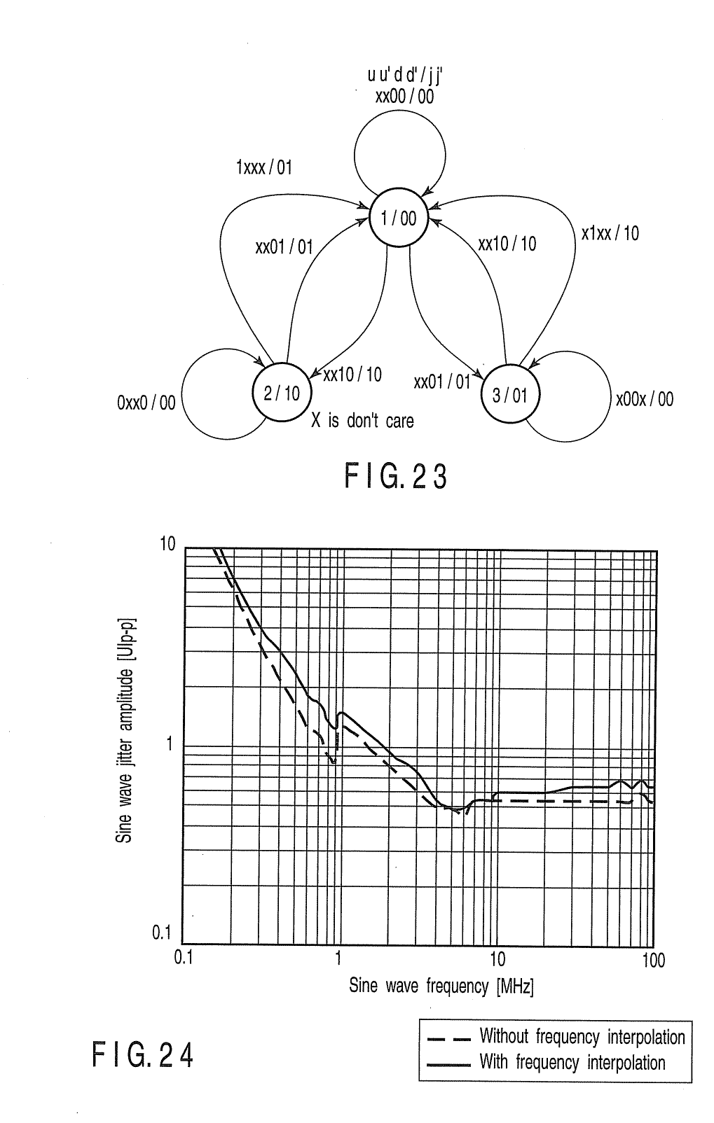

FIG. 23 is a state transition diagram of control circuit 335 used in frequency interpolation circuit 309 shown in FIG. 21. In FIG. 23 number sequences with a sign “/” inside it beside an arrow represents an input signal in the left-hand of the slash and an output signal in the right-hand of it. The number sequence represents signals u, u′, d, d′, j, j′ from the right to the left. Numbers in circles which represent the state show a state number in the left-hand of the slash and state outputs l and l′ in the right-hand of the slash.

FIG. 24 is a characteristic diagram showing the advantage offered by provision of phase interpolation circuit 309, and shows the simulation result of the tolerance to the sine wave jitter. Parameters for the simulation are F_{S}=500 ppm, n=5 steps, and T_{D}=2 cycle for ±1250 ppm frequency offset. The solid line shows the case with phase interpolation circuit 309 provided, and the dashed line shows the case without phase interpolation circuit 309 in FIG. 15 and 0 is supplied to all the terminals which otherwise would receive its outputs.

FIG. 24 clearly shows there is an improvement of the jitter tolerance of at least 0.05 [UIp−p] for substantially all frequencies. For example, when RJ component of a normal distribution is assumed to be 0.1 [UIp−p], the either-side standard deviation is usually assumed to be 1/14 of peak-to-peak. The bit error rate in this assumption is 1×10⁻¹². If the tolerance improvement for all frequencies is distributed to RJ, RJ can increase to 0.15 [UIp−p], and the bit error rate at this time is lower than 1×10⁻¹⁵ when the standard deviation of RJ is the same.

Additional advantages and modifications will readily occur to those skilled in the art. Therefore and the invention in its broader aspects is not limited to a specific details and representative embodiments shown and described herein. Accordingly and various modifications may be made without departing from the spirit or scope of the general inventive concept as defined by the appended claims and their equivalents.

What is claimed is:

1. A clock data recovery circuit which reproduces clock contained in data sequence from data sequence which is serially input comprising:
a digital control oscillator outputting reproduced clock whose frequency is controlled according to a control signal;
a phase comparator comparing a phase of the data sequence and a phase of the reproduced clock;
a digital control circuit producing the control signal in accordance with an output of the phase comparator, first control information indicating a first period for which the frequency of the reproduced clock is changed, and a second control information indicating a number of steps by which the frequency of the reproduced clock is changed.

2. The circuit according to claim 1, wherein the digital control circuit comprises:
a jitter removal filter removing a random jitter component from an output of the phase comparator;
a phase adjustment pulse generator which
generates a first frequency increase-or-decrease pulse for increasing or decreasing the phase of the reproduced clock from an output of the jitter removal filter and the first control information,
passes the output of the jitter removal filter, and
generates the first frequency increase-or-decrease pulse negating the passed output of the jitter removal filter after elapse of the first period from start of the passing of the output of the jitter removal filter;
a frequency difference detection filter accumulating the first frequency increase-or-decrease pulse for a predetermined period to detect a difference between the frequency of the reproduced clock and an average frequency of the data sequence, and generating a second frequency increase-or-decrease pulse for correcting the difference; and
a control signal generator generating the control signal from the first and second frequency increase-or-decrease pulses and the second control information.

3. The circuit according to claim 2, wherein
the output of the jitter removal filter includes a phase increase signal which increases the phase of the reproduced clock, and a phase decrease signal which decreases the phase of the reproduced clock, and
the frequency difference detection filter performs accumulation of the first frequency increase-or-decrease pulse through accumulation of a difference between the phase increase signal elongated and multiplied by the number indicated by the second control information and the phase decrease signal elongated and multiplied by the number indicated by the second control information.

4. The circuit according to claim 3, wherein the frequency difference detection filter produces the second frequency increase-or-decrease pulse through comparison, with a threshold, accumulation of the difference between the phase increase signal elongated and multiplied by the number indicated by the second control information and the phase decrease signal elongated and multiplied by the number indicated by the second control information.

5. The circuit according to claim 3, wherein the control signal generator multiplies the first frequency increase-or-decrease pulse by the number indicated by the second control information.

6. The circuit according to claim 1, wherein the digital control circuit comprises:
a jitter removal filter removing a random jitter component from an output of the phase comparator;
a first phase adjustment pulse generator which
generates a first frequency increase-or-decrease pulse for increasing or decreasing the phase of the reproduced clock from an output of the jitter removal filter and information on a second period shorter than the first period,
passes the output of the jitter removal filter, and
generates the first frequency increase-or-decrease pulse negating the passed output of jitter removal filter after elapse of the second period from start of the passing of the output of the jitter removal filter;
a second phase adjustment pulse generator which
generates a second frequency increase-or-decrease pulse for compensating a frequency offset from the output of the jitter removal filter and the first control information,
passes the output of the jitter removal filter, and
generates the second frequency increase-or-decrease pulse negating the passed output of jitter removal filter after elapse of the first period from start of the passing of the output of the jitter removal filter;
a frequency difference detection filter accumulating the first and second frequency increase-or-decrease pulses for a predetermined period to detect a difference between the frequency of the reproduced clock and an average frequency of the data sequence, and generating a third frequency increase-or-decrease pulse for correcting the difference; and
a control signal generator generating the control signal from the first, second and third frequency increase-or-decrease pulses and the second control information.

7. The circuit according to claim 6, wherein
the output of the jitter removal filter includes a phase increase signal which increases the phase of the reproduced clock, and a phase decrease signal which decreases the phase of the reproduced clock, and
the frequency difference detection filter performs accumulation of the first and second frequency increase-or-decrease pulses through adding a difference between an elongated phase increase signal and an elongated phase decrease signal and a difference between the phase increase signal multiplied by the number indicated by the second control information and the phase decrease signal multiplied by the number indicated by the second control information.

8. The circuit according to claim 6, wherein the control signal generator multiplies the first frequency increase-or-decrease pulse by the number indicated by the second control information.

9. The circuit according to claim 1, wherein the digital control circuit comprises:
a jitter removal filter removing a random jitter component from an output of the phase comparator;
a first phase adjustment pulse generator having a first memory circuit which stores an output of the jitter removal filter, and generating a first frequency increase-or-decrease pulse for increasing or decreasing the phase of the reproduced clock from the output of the jitter removal filter and an output of the first memory circuit;
a frequency interpolation circuit having a second memory circuit which stores the output of the jitter removal filter, generating a second frequency increase-or-decrease pulse for compensating a frequency offset from the output of the jitter removal filter and an output of the second memory circuit, and initializing a content in the second memory circuit when receiving the outputs of jitter removal filter with interval longer than the first period;
a frequency difference detection filter accumulating the outputs of the first and second memory circuits for a predetermined period to detect a difference between the frequency of the reproduced clock and an average frequency of the data sequence, and generating a third frequency increase-or-decrease pulse for correcting the difference; and
a control signal generator generating the control signal from the first, second and third frequency increase-or-decrease pulses and the second control information.

10. The circuit according to claim 9, wherein the control signal generator multiplies the first frequency increase-or-decrease pulse by the number indicated by the second control information.

11. The circuit according to claim 9, wherein the frequency interpolation circuit comprises:
two memory circuits each generating a pulse, and
two timers receiving the first control information and limiting length of each of pulses generated by the two memory circuits.
